(19) United States
(12) Patent Application Publication
(10) Pub. No.: US 2021/0260970 A1
(43) Pub. Date: Aug. 26, 2021

(54) VEHICLE AIR PURIFICATION SYSTEM WITH PHOTOCATALYSIS FILTRATION

(71) Applicant: MARELLI NORTH AMERICA, INC., Farmington Hills, MI (US)

(72) Inventors: Gursaran Das Mathur, Farmington Hills, MI (US); Silvia Denisse Vazquez Salazar, Farmington Hills, MI (US); Christopher Lynn Dawson, Farmington Hills, MI (US)

(73) Assignee: MARELLI NORTH AMERICA, INC., Farmington Hills, MI (US)

(21) Appl. No.: 17/180,146

(22) Filed: Feb. 19, 2021

Related U.S. Application Data
(60) Provisional application No. 62/979,876, filed on Feb. 21, 2020.

(51) Int. Cl. B60H 3/06; B60H 1/00

(52) U.S. Cl. CPC B60H 3/0608; B60H 1/00514; B60H 2001/006; B60H 1/00828; B60H 2003/0675; B60H 1/008

(57) ABSTRACT

An air purification system includes a housing having an air inlet and an air outlet, an air circulation unit disposed between the air inlet and the air outlet, and an air purification assembly disposed adjacent the air circulation unit. The air circulation unit may be configured to circulate air from the air inlet to the air outlet. The air purification assembly includes a UV-A light source, a UV-C light source, and a photocatalytic filter configured to activate responsive to light produced by each of the UV-A and UV-C light sources. The UV-A light source and the UV-C light source may be oriented to illuminate the photocatalytic filter and the air purification assembly is configured to purify the air circulated by the air circulation unit.

### CROSS-REFERENCE TO RELATED PATENT APPLICATION

This application claims the benefit of and priority to U.S. Patent Application No. 62/979,876, filed Feb. 21, 2020, the entire disclosure of which is hereby incorporated by reference herein.

### BACKGROUND

The present invention relates generally to the field of air purification within a vehicle and, more specifically, to the use of ultraviolet light and filters to remove and/or neutralize contaminants from the air.

Airborne contaminants occur in many forms, and may include viruses, bacteria, odors, particulate matter, etc. Frequently, contaminants are spread through contact between an individual (human or animal) and spaces, and/or other individuals. The spread of contaminants and impurities is exacerbated in enclosed spaces, such as vehicles, where surfaces and air therein is shared among multiple individuals—either simultaneously or successively. Increasing use of ridesharing (e.g., carpooling, public transit) and autonomous vehicles will correspondingly increase the amount of contaminants that enter and reside in vehicles, which increases the risk of contaminant spread among vehicle occupants. Contaminated air within a vehicle may be recirculated by a heating, cooling, or air conditioning (HVAC) system, which may further accelerate contaminant spread.

Consequently, it would be advantageous to provide a system capable of purifying and/or neutralizing contaminants from the air that may be used within a vehicle.

### SUMMARY

According to one aspect of the present disclosure, an air purification system includes a housing having an air inlet and an air outlet, an air circulation unit disposed between the air inlet and the air outlet, and an air purification assembly disposed adjacent the air circulation unit. The air circulation unit is configured to circulate air from the air inlet to the air outlet and the air purification assembly includes a UV-A light source, a UV-C light source, and a photocatalytic filter configured to activate responsive to light produced by each of the UV-A and UV-C light sources. The UV-A light source and the UV-C light source may be oriented to illuminate the photocatalytic filter the air purification assembly is configured to purify the air circulated by the air circulation unit.

In various embodiments, the UV-A light source is oriented at a first angle relative to the photocatalytic filter and the UV-C light source is oriented at a second angle relative to the photocatalytic filter. In some embodiments, the first angle is substantially the same as the second angle. In other embodiments, the housing includes a first housing section and a second housing section coupled to the first housing section, wherein the air inlet is formed within a bottom portion of each of the first housing section and the second housing section, and wherein the air outlet is formed within a top portion of each of the first housing section and the second housing section. In yet other embodiments, each of the air inlet and the air outlet are covered by a mesh covering. In various embodiments, the air purification system includes a mounting apparatus coupled to the housing. In some embodiments, a speed of air circulated by the air circulation unit is controlled based on at least one of a runtime or an impurity level. In other embodiments, the air purification system includes a controller, wherein the controller is configured to control at least one of a runtime, an air circulation rate, or an intensity of the UV-A and the UV-C light sources. In yet other embodiments, the air circulation unit includes at least one of a blower or a fan. In various embodiments, each of the UV-A light source and the UV-C light source include one or more light emitting diodes (LEDs). In some embodiments, an intensity of the LEDs within each of the UV-A light source and the UV-C light source is adjusted based on a runtime of the air purification system.

According to another aspect of the present disclosure, an air purification system includes an outer shell, an inlet housing coupled to a first end of the outer shell, and an outlet housing coupled to a second end of the outer shell. The air is received through the inlet housing and expelled through outlet housing, and the outer shell is configured to enclose an air circulation unit and an air purification assembly. The air purification assembly includes a first UV light source and a second UV light source, and a photocatalytic filter configured to activate responsive to light produced by each of the first UV light source and the second UV light source. The first UV light source and the second UV light source are configured to illuminate the photocatalytic filter and are positioned respectively at a first angle and a second angle relative to the photocatalytic filter. The air purification assembly is configured to purify the air circulated by the air circulation unit.

In various embodiments, the first UV light source is a UV-A light source and the second UV light source is a UV-C light source. In some embodiments, each of the first UV light source and the second UV light source are LEDs. In other embodiments, an intensity of the first UV light source and the second UV light source is adjusted to target neutralization of one or more impurities. In various embodiments, a runtime of at least one of the air purification assembly or the air circulation unit is adjusted to target neutralization of one or more impurities. In some embodiments, the one or more impurities is selected from the list comprising: Bacillus globigii, Phi-174, Apergilus Niger, Staphylococcus epidermidis, Erwinia herbicola, Escherichia virus MS2, SARS-Cov-2, and Coronavirus. In various embodiments, the air purification system includes a noise-dampening material disposed between the outer shell and at least one of the air purification assembly or the air circulation unit. In various embodiments, an inside surface of at least one of the outer shell, the inlet housing, or the outlet housing is coated with a UV-reflective coating.

According to yet another aspect of the present disclosure, a method of purifying ambient air in a confined space using an air purification system includes illuminating, by a first UV-light source and a second UV-light source, a photocatalytic filter disposed within a filter housing. The method further includes circulating, by an air circulation unit disposed adjacent the photocatalytic filter, air through the photocatalytic filter. The photocatalytic filter activates responsive to illumination by the first UV light source and the second UV light source, and the photocatalytic filter is configured to neutralize volatile organic compounds (VOCs) within the air when activated. The air circulation unit is configured to draw the air through an inlet housing and expel the air through an outlet housing. The inlet housing and the outlet housing are respectively coupled to a first end and a second end of an outer shell. The outer shell is configured to contain the first UV light source, the second UV light source, and the filter housing, and the air circulation unit. The first UV light source is a light emitting diode tuned to a UV-A wavelength and the second UV light source is a light emitting diode tuned to a UV-C wavelength.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

A clear conception of the advantages and features constituting the present disclosure, and of the construction and operation of typical mechanisms provided with the present disclosure, will become more readily apparent by referring to the exemplary, and therefore non-limiting, embodiments illustrated in the drawings accompanying and forming a part of this specification, wherein like reference numerals designate the same elements in the several views, and in which:

FIG. 1 shows a schematic representation of an air purification system, according to an exemplary embodiment.

FIG. 2 shows a schematic representation of an air purification system, according to an exemplary embodiment.

FIG. 3 shows a schematic representation of an air purification system, according to an exemplary embodiment.

FIG. 4 shows a schematic representation of an air purification system, according to an exemplary embodiment.

FIG. 5 shows a schematic representation of an air purification system, according to an exemplary embodiment.

FIG. 6 shows a schematic representation of an air purification system, according to an exemplary embodiment.

FIG. 7 shows a perspective view of an air purification system configured for vehicle console installation, according to an exemplary embodiment.

FIG. 8 shows an alternate perspective view of the air purification system of FIG. 7, according to an exemplary embodiment.

FIG. 9 shows a side view of the air purification system of FIG. 7, according to an exemplary embodiment.

FIG. 10 shows an alternate side view of the air purification system of FIG. 7, according to an exemplary embodiment.

FIG. 11 shows a top view of the air purification system of FIG. 7, according to an exemplary embodiment.

FIG. 12 shows a bottom view of the air purification system of FIG. 7, according to an exemplary embodiment.

FIGS. 13-14 show front and perspective cross-sectional views of the air purification system of FIG. 7 taken along line 14-14 of FIG. 11, according to an exemplary embodiment.

FIG. 15 shows a perspective cross-sectional view of the air purification system of FIG. 7 taken along line 15-15 of FIG. 12, according to an exemplary embodiment.

FIG. 16 shows a top cross-sectional view of the air purification system of FIG. 7 taken along line 16-16 of FIG. 9, according to an exemplary embodiment.

FIGS. 17-18 show perspective views of an air purification assembly of the air purification system of FIG. 7, according to an exemplary embodiment.

FIG. 19 shows an end view of the air purification assembly of FIGS. 17-18, according to an exemplary embodiment.

FIG. 20 shows a perspective view of an air passage assembly of the air purification system of FIG. 7, according to an exemplary embodiment.

FIG. 21 shows an end view of the air passage assembly of FIG. 20, according to an exemplary embodiment.

FIG. 22 shows a top cross-sectional view of the air passage assembly of FIG. 20 taken along line 20-20 of FIG. 20, according to an exemplary embodiment.

FIG. 23 shows an end cross-sectional view of the air purification system of FIG. 7 near a blower assembly taken along line 24-24 of FIG. 10, according to an exemplary embodiment.

FIG. 24 shows a perspective cross-sectional view of the air purification system of FIG. 7 near the blower assembly taken along line 24-24 of FIG. 10, according to an exemplary embodiment.

FIG. 25 shows a perspective view of an air purification system configured as a standalone unit, according to an exemplary embodiment.

FIG. 26 shows a front side view of the air purification system of FIG. 25, according to an exemplary embodiment.

FIG. 27 shows a back side view of the air purification system of FIG. 25, according to an exemplary embodiment.

FIG. 28 shows a side cross-sectional view of the air purification system of FIG. 25 taken along line 28-28 of FIG. 25, according to an exemplary embodiment.

FIG. 29 shows a side cross-sectional view of the air purification system of FIG. 25 taken along line 29-29 of FIG. 25, according to an exemplary embodiment.

FIG. 30 shows a perspective cross-sectional view of the air purification system of FIG. 25 taken along line 30-30 of FIG. 26, according to an exemplary embodiment.

FIG. 31 shows an end cross-sectional view of the air purification system of FIG. 25 taken along line 30-30 of FIG. 26, according to an exemplary embodiment.

FIG. 32 shows a perspective view of an air purification system configured as a compact standalone unit, according to an exemplary embodiment.

FIG. 33 shows a front view of the air purification system of FIG. 32, according to an exemplary embodiment.

FIG. 34 shows a back view of the air purification system of FIG. 32, according to an exemplary embodiment.

FIG. 35 shows a side view of the air purification system of FIG. 32, according to an exemplary embodiment.

FIG. 36 shows a top view of the air purification system of FIG. 32, according to an exemplary embodiment.

FIG. 37 shows a bottom view of the air purification system of FIG. 32, according to an exemplary embodiment.

FIG. 38 shows a side cross-sectional view of the air purification system of FIG. 32 taken along line 38-38 of FIG. 37, according to an exemplary embodiment.

FIG. 39 shows a perspective cross-sectional view of the air purification system of FIG. 32 taken along line 38-38 of FIG. 37, according to an exemplary embodiment.

FIG. 40 shows an end cross-sectional view of the air purification system of FIG. 32 taken along line 40-40 of FIG. 34, according to an exemplary embodiment.

FIG. 41 shows an end cross-sectional view of the air purification system of FIG. 32 taken along line 41-41 of FIG. 35, according to an exemplary embodiment.

FIG. 42 shows a perspective view of an air purification system configured as a small standalone unit, according to an exemplary embodiment.

FIG. 43 shows an exploded view of the air purification system of FIG. 42, according to an exemplary embodiment.

FIGS. 44-47 show perspective views of the air purification system of FIG. 42 coupled to a mounting system, according to various exemplary embodiments.

FIGS. 48A-48B show alternate views of an air purification assembly of an air purification system, according to exemplary embodiments.

FIG. 49 shows perspective views of a blower assembly and an air purification assembly for an air purification system, according to exemplary embodiments.

FIG. 50 shows a perspective view of an air purification assembly for an air purification system, according to an exemplary embodiment.

FIG. 51 shows examples of fan and blower designs that could be implemented within a standalone air purification system, according to exemplary embodiments.

FIGS. 52-53 show alternate views of a blower that could be implemented within a standalone air purification system, according to an exemplary embodiment.

FIG. 54 shows a perspective view of a standalone air purification system, according to an exemplary embodiment.

FIG. 55 shows various components that may be included within an air purification system that is configured as a small standalone unit, according to an exemplary embodiment.

FIGS. 56-57 show an example blower and purification assembly that could be implemented within an air purification system that is configured as a small standalone unit, according to an exemplary embodiment.

FIG. 58 shows an example blower that could be implemented within an air purification system that is configured as a small standalone unit, according to an exemplary embodiment.

FIG. 59 shows a front view of an air purification system configured as a small standalone unit, according to an exemplary embodiment.

FIG. 60 shows example noise-reducing materials that could be implemented within an air purification system, according to an exemplary embodiment.

FIGS. 61 and 62 show perspective views of an air purification system, according to an exemplary embodiment.

FIG. 63 shows an exploded view of the air purification system of FIGS. 61 and 62, according to an exemplary embodiment.

FIG. 64 shows a cross-sectional view of the air purification system of FIGS. 61 and 62 taken along line 64-64 of FIG. 61, according to an exemplary embodiment.

FIG. 65 shows a perspective view of an air purification system, according to an exemplary embodiment.

FIG. 66 shows a top view of the air purification system of FIG. 65, according to an exemplary embodiment.

FIG. 67 shows an alternate perspective view of the air purification system of FIG. 65, according to an exemplary embodiment.

FIG. 68 shows a rear cross-sectional view of the air purification system of FIG. 65 taken along line 68-68 of FIG. 66, according to an exemplary embodiment.

FIG. 69 shows a perspective cross-sectional view of the housing of the air purification system of FIG. 65 taken along line 68-68 of FIG. 66, according to an exemplary embodiment.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

One embodiment of the disclosure relates to an air purification system for a vehicle, including a housing having an airflow path therethrough, a photocatalytic filter comprising a first photocatalyst and a second photocatalyst, and an air circulator (e.g., blower, fan). The system further includes a first ultraviolet (UV) light source and a second UV light source, which are disposed within the housing near the photocatalytic filter and each configured to energize the first and second photocatalysts, respectively. The first UV light source may comprise a plurality light-emitting diodes (LEDs) tuned to a UV-A wavelength. The second UV light source may include one or more LEDs tuned to a UV-C wavelength. The first and second photocatalysts, in conjunction with the UV light sources, are configured to remove contaminants (e.g., odor, bacteria, volatile organic compounds, viruses) from air flowing through the system.

According to an exemplary embodiment, the system may be configured as a standalone unit that may be retrofit to a vehicle's existing air circulation system. The air purification system may be configured to purify air entering or exiting the HVAC system within a vehicle, or the air purification system may be configured to integrate with the HVAC system itself.

In another embodiment, the system may be configured as a separate standalone unit, wherein the air purification system may implement a small fan to drawn in and/or force out air within a vehicle, purifying it in the process. The system may include a containing body within air inlets and outlets. In various embodiments, the system may be configured to be powered via universal serial bus (USB), an auxiliary power outlet, batteries, or any other suitable power source available within a vehicle. The standalone system may enable specific placement throughout a vehicle—either mounted in a specific location or free standing.

In another embodiment, the system may be a compact standalone unit, configured for placement within a small recess within a vehicle—such as a cup holder. The compact system may include a small containing body with air inlets and outlets, a correspondingly small blower or air circulating mechanism, and UV LEDs to purify air circulating within a vehicle. The compact system provides removal of contaminants while maintaining a small footprint, as space within a vehicle is often limited. Furthermore, use of LEDs not only reduces the amount of space required for the UV light source(s), but also contributes to a reduction in the amount of energy required to power the system, a reduction in the overall mass of the system, and an increase in system durability.

In various embodiments, the system may be implemented in a multitude of automotive applications including, but not limited to, in ride sharing vehicles, autonomous vehicles, and electric vehicles. In other embodiments, the system may be implemented within high occupancy transportation systems including, but not limited to, buses, trains, and planes. In various embodiments, the system may be implemented in a multitude of other applications including, but not limited to, in hospitals, homes (e.g., kitchens, bedrooms), or any other location where air may be contaminated with viruses, bacteria, odors, particulate matter, etc.

Referring generally to the figures, an air purification system includes a main housing with an airflow path therethrough, comprising at least an inlet and an outlet. The system further includes a photocatalytic filter comprising a first and a second photocatalyst, one or more UV light sources located near the filter, and a mechanism for moving air through the system (e.g., blower, fan). In various implementations, one of the first photocatalyst or the second photocatalyst may be configured to remove odor from the air, and the other of the first photocatalyst or the second photocatalyst may be configured to remove bacteria from the air.

The system also includes a mechanism for connecting to a power supply available within a vehicle. In various implementations, the system is configured to be coupled within existing ductwork in a vehicle such that air circulating through air ducts may also be purified upstream or downstream of existing heating, cooling, or conditioning operations driven by the vehicle's HVAC system.

In various implementations, the system is configured as a standalone unit, wherein the system may be freestanding within a vehicle to provide air purification. In other implementations, the unit may be mounted or otherwise coupled to a specific location within a vehicle. In various embodiments, the system may be mounted to vehicle surfaces such as a ceiling, interior side panels, floor spaces, etc. In other embodiments, the system may be positioned beneath seats or other recesses within a vehicle.

In various implementations, the system is configured as a compact standalone unit, wherein the system is configured to implement LEDs tuned to UV wavelengths to reduce the footprint, power draw, and heat generation of the system. In various other implementations, the system may include UV light sources in the form of tubes or lightbulbs. The system may also be configured to be mounted to or fit within specific spaces within a vehicle (e.g., having a portion coupled to or received within a cup holder).

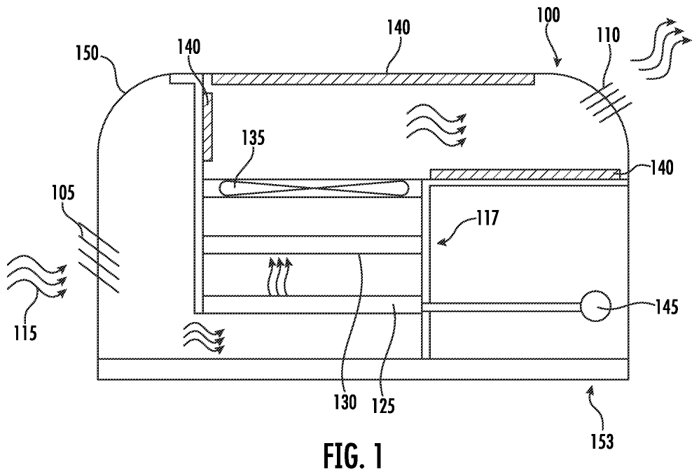

Turning now to the accompanying figures, and referring specifically to FIG. 1, a schematic side view of an air purification system 100 is shown according to an exemplary embodiment. As shown in FIG. 1, the system 100 is configured to rest or be mounted to a vehicle location via surface 153 and includes air passageways 105 and 110, which allow air 115 to flow into and out of a main body 150. Air entering the main body 150 is purified by purifying assembly 117, which includes photocatalyst-energizing UV light sources 125 and filter 130. A fan 135 disposed within main body 150 moves air purified by the purifying assembly 117 out of main body 150, such as via passageway 110. Surfaces within main body 150 that are proximal to fan 135 may be lined with sound absorbing material 140 (e.g., acoustic mineral wool, acoustic cotton batt, acoustic foam pads, etc.) to reduce noise generated by system 100. Elements within purifying assembly 117 and/or fan 135 may be supplied power via connection 145. In various embodiments, connection 145 may facilitate connection to a contained one or more batteries, an auxiliary power outlet (e.g., 12V outlet), a USB outlet, etc.

Although FIG. 1 shows passageway 105 as an airflow inlet and passageway 110 as an outlet, wherein fan 135 is downstream of purifying assembly 117, various implementations of system 100 may include fan 135 either upstream or downstream of the purifying assembly 117. Furthermore, though FIG. 1 shows filter 130 located downstream of UV light sources 125, various implementations of system 100 may include filter 130 and UV light sources 125 in any order.

In various embodiments, UV light sources 125 may include a first UV light source and a second UV light source. Various embodiments of system 100 may implement UV-A as a first light source and UV-C as a second UV light source, or vice versa. In various implementations, LEDs tuned to UV light may be used as UV light sources 125 to enable reductions in space and energy required by system 100. In various embodiments, UV light sources 125 may be configured within main body 150 such that UV light LEDs are positioned substantially perpendicular to the direction of air flow through system 100 (e.g., oriented across, vertically, horizontally, etc.). In other embodiments, UV light sources may be arranged radially along air flow pathways within main body 150, such as mounted to an interior surface of an air flow pathway.

In various embodiments, filter 130 may include one or more parts, which may include a photocatalytic layer and a non-photocatalytic layer. In various implementations, the photocatalytic later of filter 130 may include titanium dioxide (TiO₂) and carbon, or other similar compounds known in the art that are configured to remove and/or neutralize viruses, bacteria, and volatile organic compounds (VOCs) from circulating air. Example VOCs that may be removed by filter 130 may include, but are not limited to, odors, mold, mildew, etc. Other example VOCs may include acetaldehyde, formaldehyde, benzene, toluene, xylene, or other materials that may be found within a vehicle, such as debris or decomposition materials from vehicle carpet, adhesives, tapes, solvents, paints, etc. In various implementations, the non-photocatalytic layer of filter 130 may include a glass fiber (e.g., high-efficiency particulate air layer) or other layer comprised of materials known in the art to trap and remove particulates from circulating air. In other embodiments, filter 130 may have a single layer comprising one or more photocatalysts (e.g., TiO₂ and carbon) and non-photocatalytic elements, such as a particulate trap (e.g., glass fiber).

In various embodiments wherein the photocatalytic layer of filter 130 includes TiO₂, UV light sources 125 may output UV light, which may interact with a TiO₂ surface within filter 130 through a process known as photocatalysis to generate electrons on the surface of the photocatalytic layer. The electrons generated on the surface of the photocatalytic layer subsequently interact with water (H₂O) molecules in the air, thereby decomposing the molecules into hydroxyl (OH) radicals, which are highly reactive and short-lived forms of hydroxide ions (OH⁻). The released hydroxyl radicals neutralize hydrocarbon-containing elements passing through the air (e.g., viruses, bacteria, pathogens, VOCs, etc.) by breaking down the complex molecules into water and carbon dioxide (CO₂) constituents.

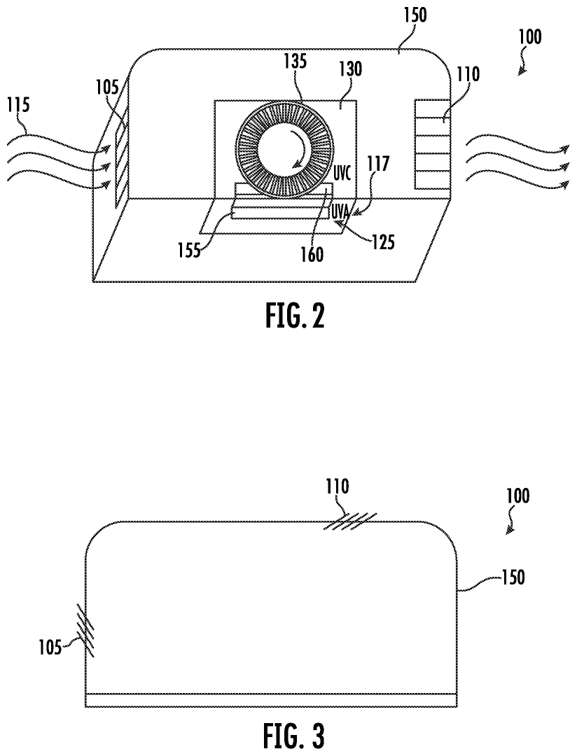

FIG. 2 shows a schematic top view of air purification system 100, according to an exemplary embodiment. In FIG. 2, air purification system 100 includes a main body 150, which has air passageways 105 and 110, enabling air 115 to flow into and out of system 100. As shown, main body 150 houses an air purification assembly 117, which includes one or more UV light sources 125. FIG. 2 shows UV light sources 125 to include a UV-A light source 155 and a UV-C light source 160. UV light sources 125 are configured to energize photocatalysts within filter 130, which enables the removal and/or neutralization of contaminants within air flowing through system 100. A fan or blower 135 within main body 150 is configured to force air purified by purification assembly 117 to exit system 100 (via passageway 110).

FIG. 3 shows a schematic side view of an air purification system 100, illustrating alternate configurations for air passageways 105 and 110 according to various embodiments. In various embodiments, passageways 105 and 110 may be positioned at any location along main body 150. In various embodiments, passageway 105 may be an airflow inlet, which allows air to enter system 100, and passageway 110 may an airflow outlet, which allows air to exit system 100. In other embodiments, air may flow in through passageway 110 and out via passageway 105.

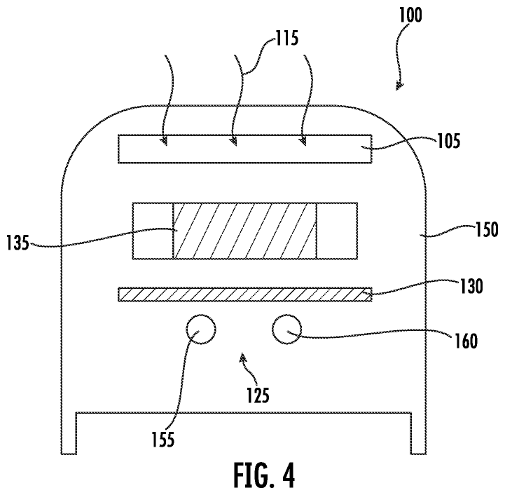

FIG. 4 shows a schematic cross-sectional view of air purification system 100, according to an exemplary embodiment. FIG. 4 illustrates a potential configuration of UV light sources 125 (including UV-A and UV-C light sources 155 and 160, respectively), filter 130, and fan 135 within main body 150 of system 100. FIG. 4 also shows an air passageway 105 located on a side of main body 150, facilitating air flow either in or out of system 100.

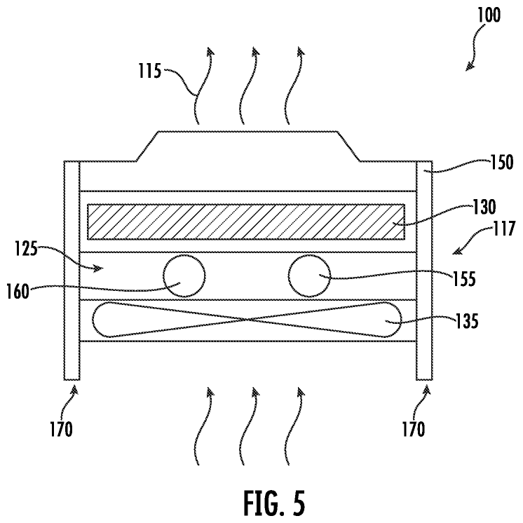

FIG. 5 shows an alternate schematic end view of air purification system 100, according to an exemplary embodiment. FIG. 5 illustrates a potential configuration of UV light sources 125 (including UV-A and UV-C light sources 155 and 160, respectively), filter 130, and fan 130 within main body 150. As shown in FIG. 5, air 115 may flow into system 100 via a passageway located on a substantially bottom portion of main body 150 and exit via a passageway located on a substantially top portion of main body 150. In various embodiments, air 115 may flow into and out of system 100 via passageways located on a substantially top portion of main body 150, a substantially bottom portion of main body 150, on one or more sides of main body 150, or a combination thereof. FIG. 5 shows an implementation of system 100 wherein fan 135 is located upstream relative to purification assembly 117, and UV light sources 125 are located upstream relative to filter 130 within purification assembly 117. FIG. 5 shows a configuration of system 100 wherein main body 150 includes legs 170, which enable the system to be stabilized on a surface while allowing airflow into or out of a passageway located on a substantially bottom portion of the main body 150. In other implementations, system 100 may be inserted into existing air ducts within a vehicle to purify air flowing therethrough, wherein legs 170 may be used to couple system 100 to existing duct surfaces. According to various other exemplary embodiments, the size, shape, and configuration of the legs and other components may differ based on a variety of factors.

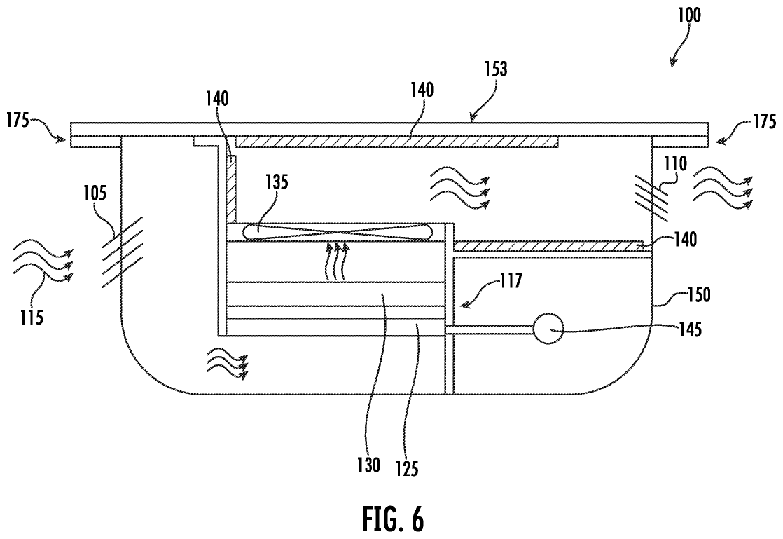

FIG. 6 shows a schematic side view of a system 100, according to an exemplary embodiment. As shown in FIG. 6, system 100 may be configured such that main body 150 includes tabs 175, which enable mounting of system 100 along a surface 153. In various implementations, system 100 may be mounted (via tabs 175) to a ceiling or interior wall of a vehicle to enable air purification therein.

Referring generally to FIGS. 1-6, system 100 may be configured such that purification assembly 117 is situated within main body 150 in a location that enables replacement and/or servicing of UV light sources 125 and/or filter 130 without disassembly or invasive maintenance operations. In various implementations, main body 150 is configured to include one or more features (such as legs 170 and/or tabs 175 and/or any other type of mounting feature or structure), which enable system 100 to be mounted to one or more interior surfaces within a vehicle. Multiple features, such as legs 170 and tabs 175, further enable system 100 to retrofit within a multitude of vehicle makes and models.

In various embodiments, system 100 may be configured to have a substantially low profile to enable unobtrusive air purification within a vehicle. In various embodiments, main body 150 of system 100 may have a height of approximately 8 inches. In other embodiments, main body 150 and components of system 100 contained therein may have a maximum height of 12 inches or less. In various implementations, fan or blower 135 may be configured to enable air flow at constant and/or variable speeds. In various embodiments, airflow out of system 100, as driven by fan or blower 135, may be at speeds ranging from approximately 0.8-1.2 meters/second. In other embodiments, airflow speed out of system 100 may be greater than approximately 1.2 meters/second. In various embodiments, fan or blower 135 may operate at speeds that cause minimal vibration within system 100. In various embodiments, system 100 may implement an air circulation mechanism in place of blower 135 to force air into and out of system 100. Various embodiments implementing an air circulation mechanism may include mechanisms that cause a pressure drop within system 100, fans, or any other mechanism known in the art.

In various embodiments, system 100 may include a switch to turn it “on” or “off” In various other embodiments, system 100 may implement one or more sensors that cause system 100 to turn “on” or “off.” In these embodiments, the sensors may be configured to detect at least one of a virus, an airflow, or an occupancy. In various embodiments, air flow through system 100 may be controlled by varying a speed of a fan and/or blower coupled to system 100.

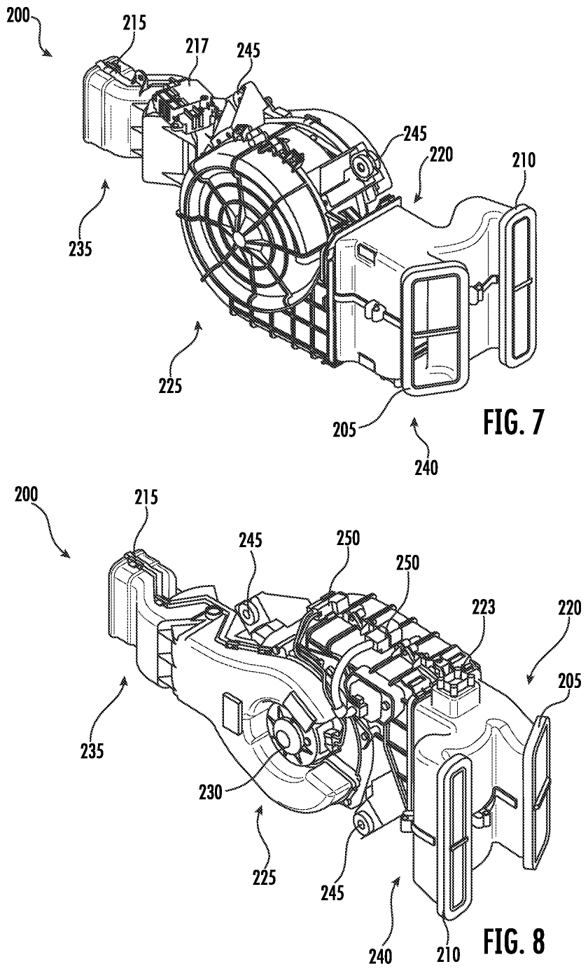

FIGS. 7-8 show perspective views of an air purification system 200 configured for coupling to ductwork within a vehicle, according to an exemplary embodiment. As shown in FIGS. 7-8, system 200 includes a purifying component 240, a blower housing component 225, and a flow control component 235. Purifying component 240 is coupled to blower housing component 225, which is further coupled to flow control component 235. Components 240, 225, and 235 are coupled via connections 245. System 200 is configured to enable air circulating within existing ducts in a vehicle console to enter system 200 via air passageways 205 and/or 210. Air that enters system 200 via passageway 215, may flow through system 200 and exit via passageways 205 and/or 210.

Purifying component 240 includes a purifying assembly 220, which may be accessible via a port 223 to enable replacing and/or servicing of contained components without disassembly of system 200. Purifying component 240 is coupled to blower assembly component 225, which houses a mechanism powered by motor 230 that facilitates drawing air into system 200 and/or forcing air out of system 200. Blower assembly component 225 is further coupled to flow control component 235, which includes an air flow control assembly 217 for facilitating control of the direction and amount of airflow entering or exiting system 200 via air passageway 205 and/or 210. Power supply to system 200, to enable operation of purifying assembly 220 and motor 230, may be provided via connections 250.

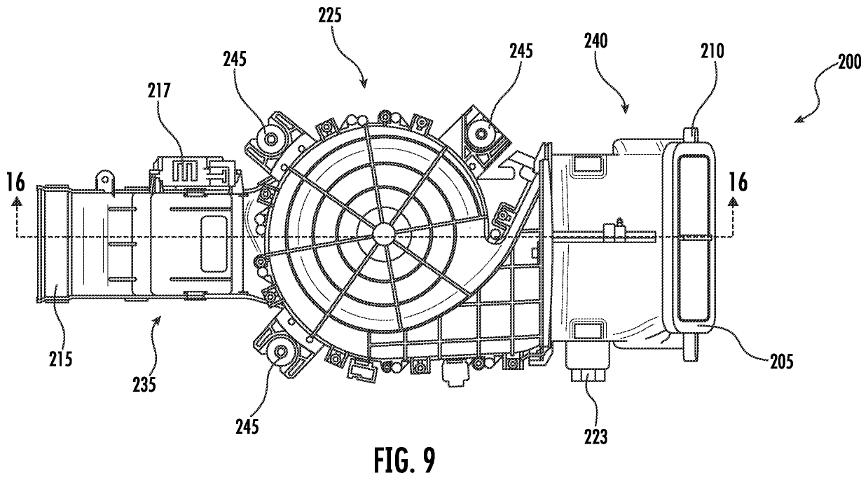

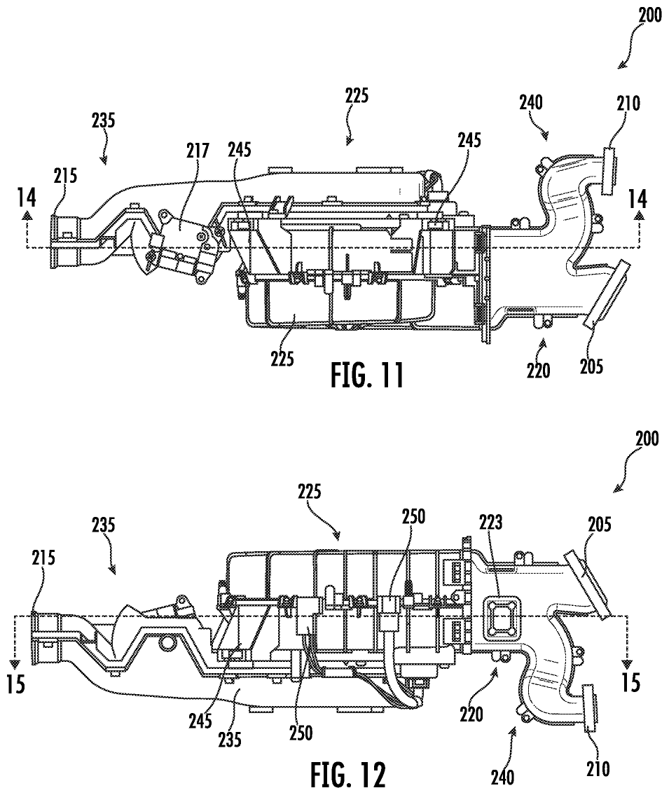

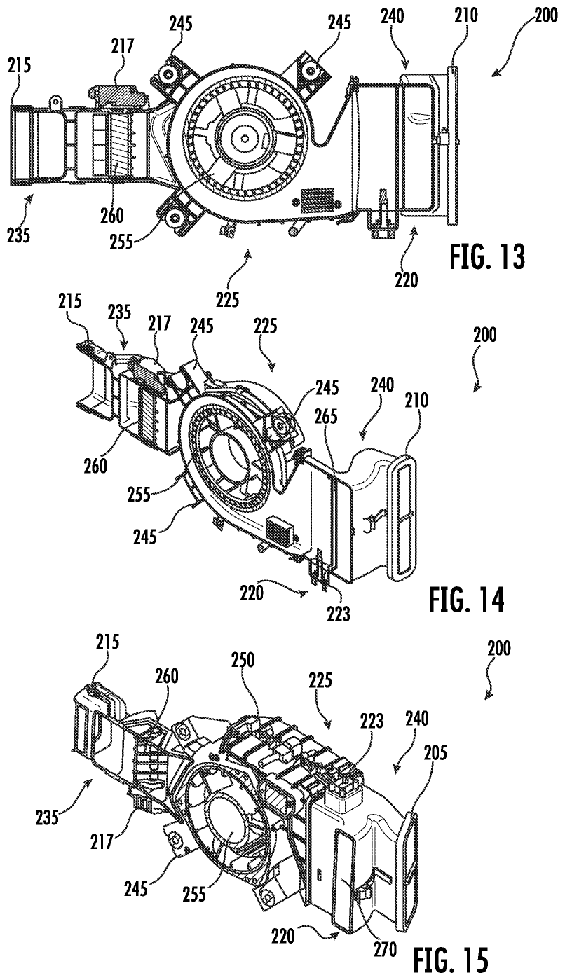

FIGS. 9-12 show side, top, and bottom views, respectively, of air purification system 200, according to an exemplary embodiment. FIGS. 9-12 further illustrate relative configurations of air purifying component 240, blower housing component 225, and flow control component 235 within system 200. FIGS. 13-15 show side cross-sectional views of system 200, according to an exemplary embodiment. FIGS. 13-14 shows a cross-sectional view of system 200 taken along line 14-14 of FIG. 11 and FIG. 15 shows a cross-sectional view of system 200 taken along line 15-15 of FIG. 12. As shown, air may flow through system 200 via passageways 205, 210, and 215. In various embodiments, air may enter system 200 through air passageway 215 in flow control component 235. Flow control component 235 includes an air flow controller 260, which enables metering of airflow in or out of air passageway 215. Air flow controller 260 may be externally accessible and/or controlled via portion 217, which enables replacement, servicing, or other manipulation of air flow controller 260 without disassembly of system 200. In various embodiments, air flow controller 260 may include a substantially rectangular piece that is centrally anchored in an air pathway within flow control component 235. After air enters and passes through flow control component 235, air is drawn into blower assembly component 225 via blower 255 (powered by motor 230). Blower 255 subsequently forces air from blower assembly component 225 into photocatalytic assembly component 240, wherein air is purified via purifying assembly 220. Air purified by purifying assembly 220 then flows out of photocatalytic assembly component 240 via air passageways 210 and/or 205.

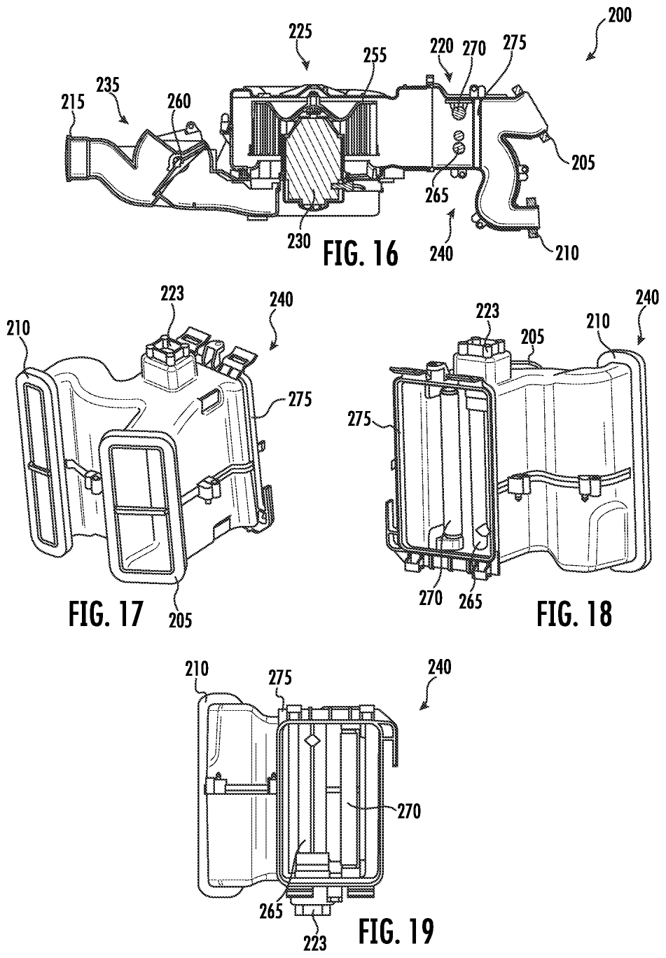

FIG. 16 shows a top cross-sectional view of system 200 taken along line 16-16 of FIG. 9, according to an exemplary embodiment. As shown, air may enter system 200 via air passageway 215, pass through flow controller 260, be drawn by blower 255, and forced through purifying assembly 220 before exiting system 200 through air passageways 205 and/or 210. Purifying assembly 220, which is located within photocatalytic assembly component 240, includes a UV light sources 265 and 270 and photocatalytic filter 275. In various embodiments, UV light sources 265 and 270 are LED lamps that are tuned to UV-A and UV-C wavelengths, respectively, and are configured to energize one or more photocatalysts (e.g., TiO₂ and carbon) within photocatalytic filter 275. FIG. 16 shows UV light sources 265 and 270 positioned in substantially vertical orientations within photocatalytic assembly component 240. In various embodiments, UV light sources 265 and/or 270 may be positioned in substantially horizontal configurations. In other embodiments, UV light sources 265 and/or 270 may be positioned along an interior surface of photocatalytic assembly component 240. FIG. 16 illustrates a configuration of system 200 wherein purification assembly 220 is located downstream of blower 255. In various other embodiments, purification assembly 220 may be located upstream relative to blower 255. FIG. 16 illustrates a configuration of purification assembly 220 wherein UV light sources 265 and 270 are located upstream relative to photocatalytic filter 275. In various other embodiments, UV light sources 265 and 270 may be positioned downstream relative to photocatalytic filter 275.

FIGS. 17-18 and FIG. 19 show perspective and end views, respectively of photocatalytic assembly component 240, according to an exemplary embodiment. As shown, photocatalytic assembly component 240 houses photocatalytic filter 275, which contains one or more photocatalysts, such as TiO2 and carbon. UV light sources 265 and 270 are positioned within photocatalytic assembly component 240 proximal to photocatalytic filter 275. UV light sources 265 and 270, which are LED lamps tuned to UV-A and UV-C wavelengths, respectively, may be accessed via port 223 to enable replacement and/or servicing without disassembly of system 200. Configuration of UV light sources 265 and 270 near photocatalytic filter 275 enable removal and/or neutralization of contaminants within air passing through system 200. As UV light sources 265 and 270 may be turned to UV-A and UV-C wavelengths, respectively, purification assembly 220 may facilitate removal of viruses, bacteria, and VOCs. In various embodiments photocatalytic filter 275 may further comprise additional layers (e.g., fiber glass), which may further enable purification assembly 220 to remove additional particulate contaminants form air passing through system 200.

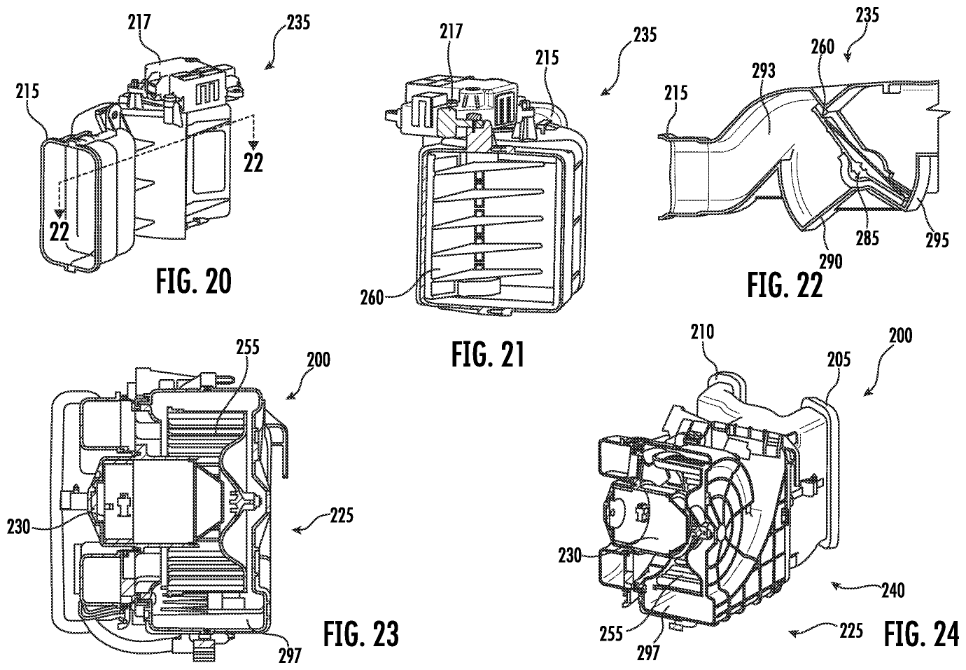

FIGS. 20-22 show alternate views of flow control component 235, according to an exemplary embodiment. FIGS. 21 and 22 show end and top cross-sectional (taken along line 22-22 of FIG. 20) views of flow control component 235, illustrating the relative configuration of air flow controller 260 within flow control component 235. As shown, air flow controller 260 may be a substantially rectangular element, configured to fit within an airway 293 within flow control component 235. Air flow controller 260 may be pinned at a location 285, enabling rotation of air flow controller 260 about location 285. In various embodiments, air flow controller 260 may be adjusted or otherwise accessed via portion 217, located on a top side of flow control component 235. Air flow controller 260 may be rotated about location 285 such that a portion of controller 260 may interface with interior surfaces 290 or 295 to meter airflow through airway 293 within flow control component 235.

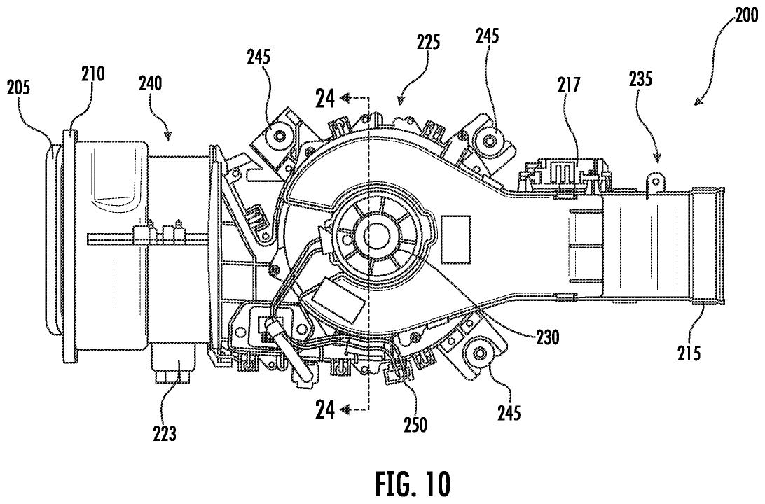

FIGS. 23 and 24 show end and perspective cross-sectional views taken along line 24-24 of FIG. 10, respectively, of system 200, according to exemplary embodiments. FIGS. 23-24 illustrate relative configurations of elements within blower assembly component 225. As shown, blower 255 is housed within blower assembly component 225 and is coupled to motor 230, which causes air to be drawn from flow control component 235 and forced into air photocatalytic assembly component 240 via an airway 297 within blower assembly component 225. In various embodiments, blower 255 and coupled motor 230 may be controlled to draw and/or force air through system 200 at specific speeds. In various embodiments, coupled motor 230 and blower 255 may be run at a constant speed or at varying speeds. In various embodiments, system 200 may implement an air circulation mechanism in place of blower 225 to force air into and out of system 200. Various embodiments implementing an air circulation mechanism may include mechanisms that cause a pressure drop within system 200, fans, or any other mechanism known in the art.

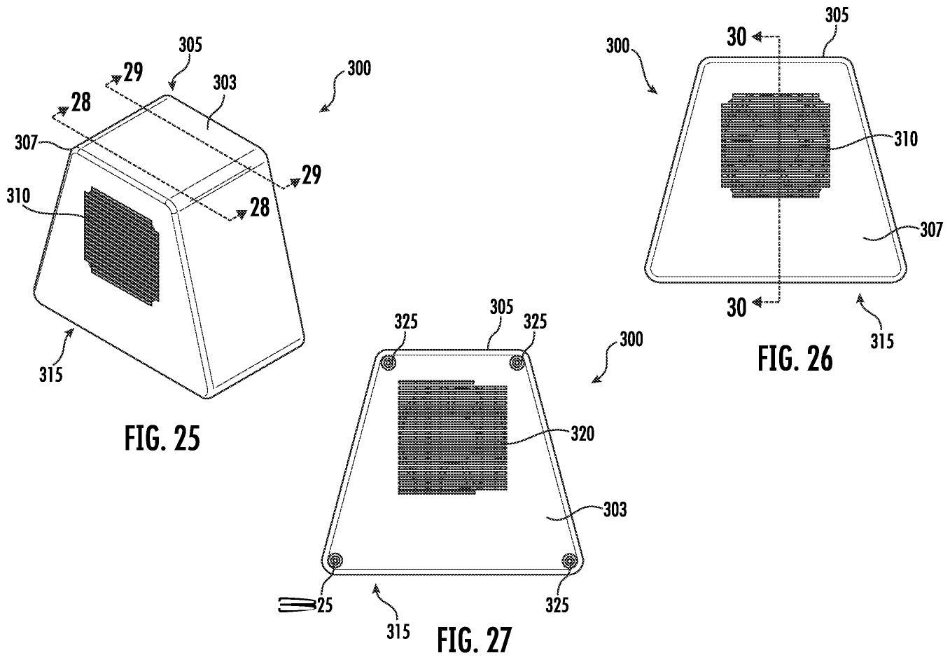

FIGS. 25, 26, and 27 shows perspective, front, and back views of an air purification system 300 configured as a standalone unit, according to an exemplary embodiment. As shown, system 300 includes a housing 305, which comprises front and back portions 307 and 303, respectively. System 300 is configured as front portion 307 includes an air passageway 310, which enables air to enter or exit system 300. Back portion 303 includes an air passageway 320 that enables air to enter or exit system 300. Front portion 307 and back portion 303 are mutually coupled (e.g., via fasteners) at locations 325. In various implementations, system 300 is configured to be placed on a surface within a vehicle that may interface with bottom portion 315. In various embodiments, air may flow into system 300 via air passageway 310 and exit system 300 via air passageway 320.

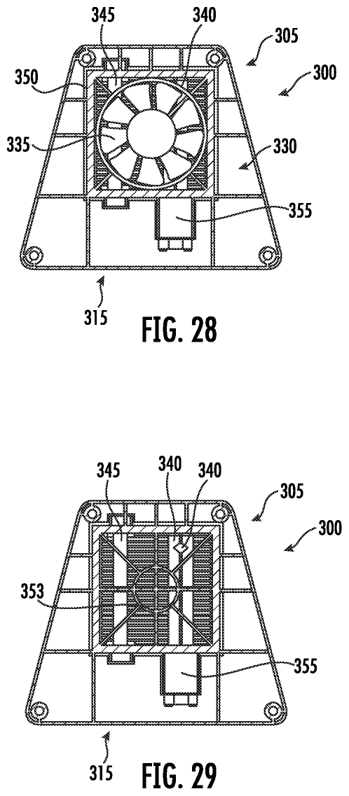

FIGS. 28-29 show side cross-sectional views of system 300, according to an exemplary embodiment. FIG. 28 shows a cross-sectional view of system 300 taken along line 28-28 of FIG. 25 and FIG. 29 shows a cross-sectional view of system 300 taken along line 29-29 of FIG. 25. As shown, main body 305 includes an air purification assembly 330, which includes a fan 335 that is configured to draw air into system 300 and force air out of system 300. Purification assembly 330 also includes a filter 353 located proximally downstream of fan 335. In various embodiments, filter 353 may include a photocatalytic portion comprising one or more photocatalysts (e.g., TiO₂ and carbon) and/or a particulate trap (e.g., HEPA filter). Purification assembly 330 additionally includes UV light sources 340 and 345, which may be LED lamps tuned to UV-A and UV-C wavelengths, respectively. UV light sources 340 and 345 are configured to energize photocatalysts within filter 353 to enable removal and/or neutralization of contaminants from air flowing through system 300. Ports 355 located below purification assembly 330 facilitate coupling of elements within purification assembly 330 to a power source. In various implementations, a coupled power source may include a battery contained within system 300, an auxiliary outlet within a vehicle, a USB port, etc.

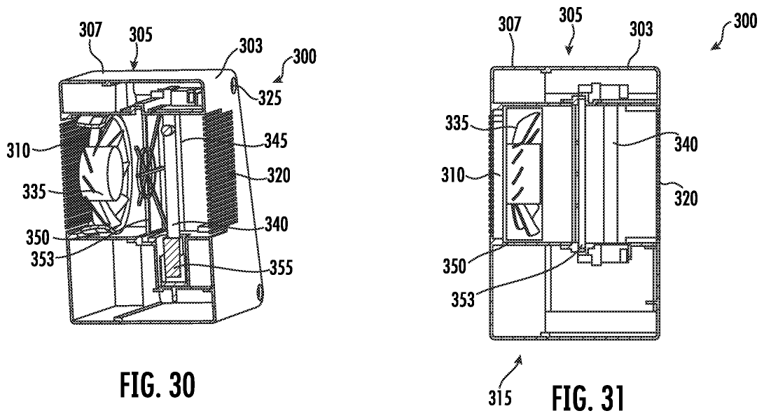

FIGS. 30 and 31 respectively show perspective and end cross-sectional views of system 300 taken along line 30-30 of FIG. 26, according to an exemplary embodiment. FIGS. 30-31 highlight relative configurations of components comprising purification assembly 330, which is disposed within housing 305. Though FIGS. 30 and 31 show system 300 facilitating airflow through fan 335, filter 353, and UV light sources 340 and 345 in sequential order, various embodiments of system 300 may be configured to house components of purification assembly 300 in any order.

Though FIGS. 25-31 illustrate housing 305 of system 300 to have a substantially trapezoidal shape, various embodiments of system 300 may include a housing 305 of any shape suitable for containing air purification assembly 330. It should be noted that the size, shape, and configuration of the air purification systems according to any of the embodiments illustrated herein may differ from what is shown. For example, the system may have a relatively low-profile configuration when intended for positioning in locations with limited available space, such as below vehicle seats or in or attached to a vehicle headliner or roof. It should be understood by those reviewing the present disclosure that all such variations are intended to fall within the scope of the present disclosure, and that the inventions discussed herein are not limited by specific configurations that happen to be illustrated in the accompanying figures.

In various embodiments, an inner surface of housing 305 may be lined with a sound absorbing material such that potential noise generated by fan 335 and/or UV light sources 340 and 345 may be reduced or minimized. In various embodiments fan 335 may be replaced by a blower and blower motor, a pressure drop system, or any other mechanism known in the art that may facilitate air flow through system 300. In other embodiments, fan 335 may be a compact fan, such as a fan typically used within computing systems.

FIGS. 25-31 show UV light sources 340 and 345 having a substantially vertical orientation within a substantially central portion of housing 305. In other embodiments, UV light sources 340 and 345 may be oriented horizontally, diagonally, circumferentially about an air passageway, mounted substantially parallel to an interior surface of housing, or in any other orientation suitable for energizing one or more photocatalysts within filter 353.

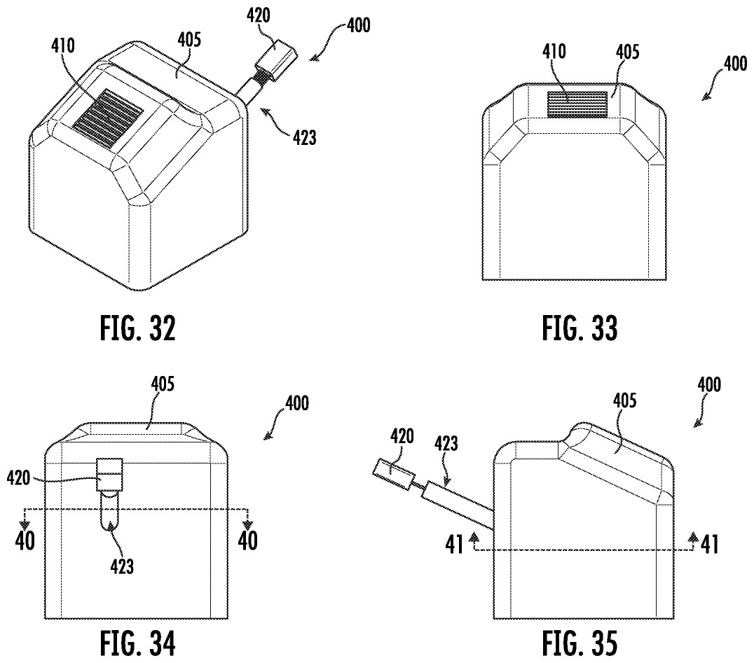

FIG. 32 and FIGS. 33-35 show perspective and side views, respectively of an air purification system 400 configured as a compact standalone unit, according to an exemplary embodiment. As shown, system 400 includes a housing 405 with an air passageway 410 located on an upper portion of main body 405. System 400 further includes a connecting portion 423, which enables power supply via port 420 to air purifying components disposed within housing 405. Connecting portion 423 may be a cable or wire harness that facilitates connection of system 400 to a power supply.

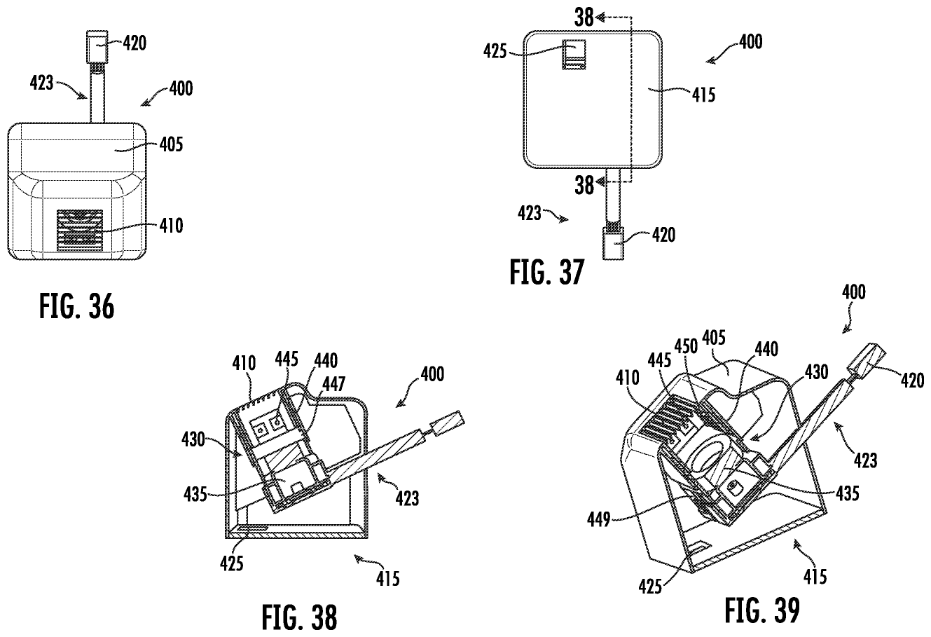

FIGS. 36 and 37 show top and bottom views, respectively, of system 400, according to an exemplary embodiment. As shown, system 400 includes an opening 425 on bottom surface 415 of housing 405, which enables air to flow into or out of system 400. FIGS. 38 and 39 show side cross-sectional and perspective cross-sectional views (taken along line 38-38 of FIG. 37), respectively of system 400, according to an exemplary embodiment. As shown in FIG. 38, system 400 includes a purification assembly 430 disposed within housing 405, which further includes a filter with TiO₂ and/or carbon. Purification assembly 430 includes UV light sources 445 and 450 mounted on an interior surface of a structure 440 within purification assembly 430. UV light sources 445 and 450 may be LEDs tuned to UV-A and/or UV-C wavelengths, which may remove and/or neutralize contaminants within air flowing through system 400. Air purification assembly 430 further includes a blower 435, which is coupled to structure 440 via a coupling component 447. Power is suppled to blower 435 via connecting portion 423. In various embodiments, air passageway 410 and/or opening 425 may be adjusted to optimize system 400 performance for noise and/or pressure drop.

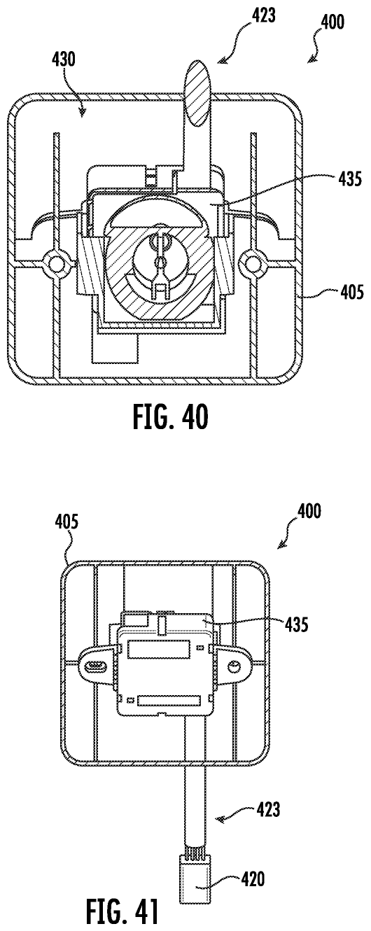

FIGS. 40 and 41 show top cross-sectional and bottom cross-sectional views, respectively, of system 400 according to an exemplary embodiment. FIG. 40 shows a cross-sectional view of system 400 taken along line 40-40 of FIG. 34, and FIG. 41 shows a cross-sectional view of system 400 taken along line 41-41 of FIG. 35. FIGS. 40 and 41 show relative configurations of components disposed within housing 405. As shown, connecting portion 423 is coupled to purification assembly 430, thereby supplying power to blower 435 and/or UV light sources 440 and 445.

In various embodiments, air may be drawn into system 400 through opening 425 via airway 449 within blower 435. Air drawn into system 400 may then be forced into purification assembly 430, wherein contaminants within the air are removed and/or neutralized by UV light sources 445 and 450. Purified air is then forced out of system 400 through air passageway 410 (via blower 435). In various other embodiments, operations of system 400 may be reversed such that blower 435 draws air into system 400 via air passageway 410 and forces purified air out through opening 425. In various embodiments, system 400 may implement an air circulation mechanism in place of blower 435 to force air into and out of system 400. Various embodiments implementing an air circulation mechanism may include mechanisms that cause a pressure drop within system 400, fans, or any other mechanism known in the art.

In various embodiments, system 400 is configured to have dimensions that enable placement within relatively small spaces within a vehicle. In various embodiments, system 400 may be configured to fit within a cup holder or other small recess within a vehicle. In other embodiments, system 400 may be configured to be mounted to a surface within an interior of a vehicle.

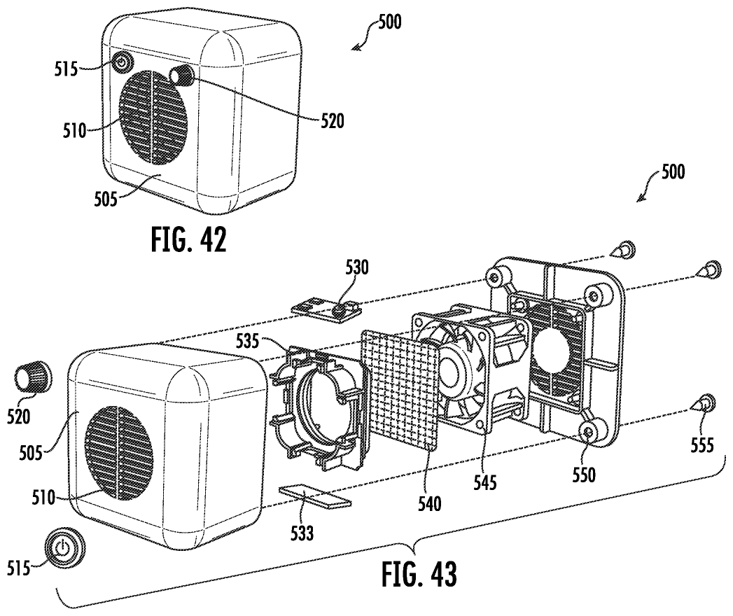

FIGS. 42-43 show perspective and exploded views, respectively, of an air purification system 500 configured as a small standalone unit, according to an exemplary embodiment. In various implementations, system 500 may be used within a multitude of transportation systems including, but not limited to, standard vehicles, ride sharing vehicles, autonomous vehicles, electric vehicles, buses, trains, planes, and other high occupancy vehicles. As shown in FIG. 42, system 500 includes a main body 505 with an air passageway 510 that allows air to flow into and/or out of system 500. System 500 may be turned “on” or “off” using button 515. System 500 further includes a knob 520, which may control air flow speed through system 500.

FIG. 43 shows an exploded view of system 500, illustrating additional components disposed within housing 505. As shown in FIG. 43, system 500 includes a fixture 535, which holds UV light sources 530 and 533. In various embodiments, UV light sources 530 and 533 may be LEDs tuned to UV-A and UV-C wavelengths, respectively. In various other embodiments, UV light sources 530 and 533 may each include at least one of an LED tuned to UV-A and UV-C wavelength. In yet other embodiments, UV light sources 530 and 533 may be light tubes or bulbs, configured to provide UV-A and UV-C light within system 500. Fixture 535 is further coupled to a filter 540, which includes at least one photocatalyst (e.g., TiO₂, carbon). In various embodiments, each of UV light sources 530 and 533 may be oriented at respective first and second angles relative to a plane defined by the filter 540. In various embodiments, filter 540 may also include non-photocatalytic elements, such as glass fibers, for filtering particulate contaminants from air flowing through system 500.

System 500 includes a fan 545, which may be pull-through fan that draws air into system 500. Main body 505 of system 500 is coupled to a back plate 550 via fasteners 555, which fan 545 and adjacent filtering and UV light-providing components.

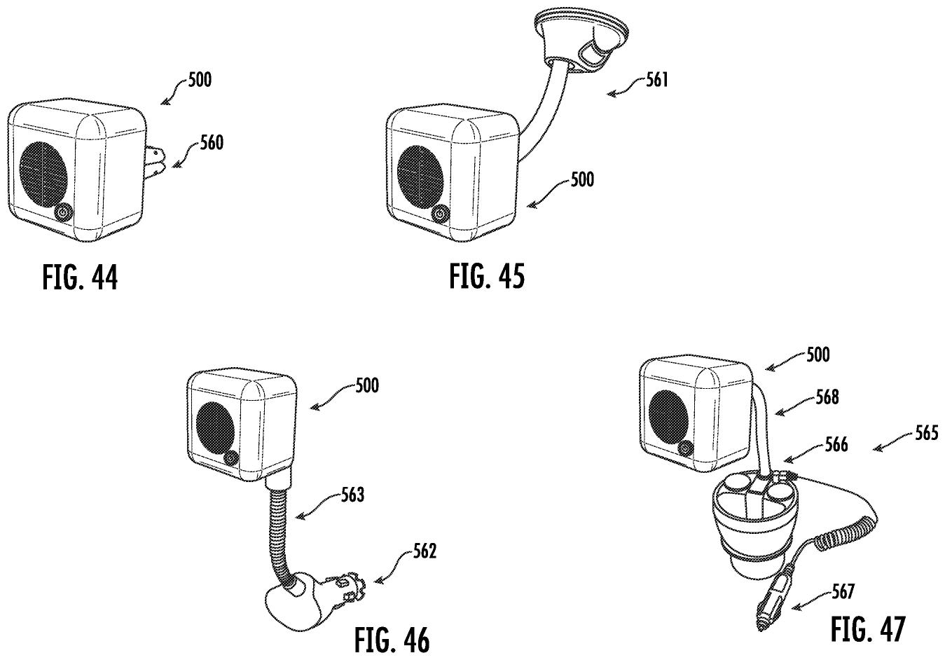

FIGS. 44-47 show perspective views of air purification system 500 coupled to an apparatus to facilitate mounting within a vehicle, according to various exemplary embodiments. In various embodiments, a mounting apparatus may be coupled to back plate 550. As shown in FIG. 44, system 500 may be coupled to a mounting apparatus 560, which may enable system 500 to be coupled to a vent within a vehicle. FIG. 45 shows system 500 coupled to a mounting apparatus 561, which enables system 500 to be coupled to a ceiling or other surface (e.g., within a vehicle). FIG. 46 shows system 500 coupled to a mounting apparatus 562, which enables system 500 to be connected to power via an auxiliary power outlet (e.g., 12V socket, cigarette lighter) within a vehicle. As shown in FIG. 46, mounting apparatus 560 may also be configured to suspend system 500 a distance away from a connected power source via a moveable arm 563. FIG. 47 shows system 500 coupled to a mounting apparatus 565, which would enable system 500 to sit within a recess (via a base 566), such as a cup holder, within a vehicle and receive power via a connection 567 to an auxiliary power outlet (e.g., 12V socket, cigarette lighter). As shown, the mounting apparatus 565 may also include an arm 568, which may be used to orient, pivot, or otherwise position the air purification system 500. Referring generally to FIGS. 44-47, mounting apparatus 560, 561, 562, 565 may include additional controls to facilitate operation of system 500.

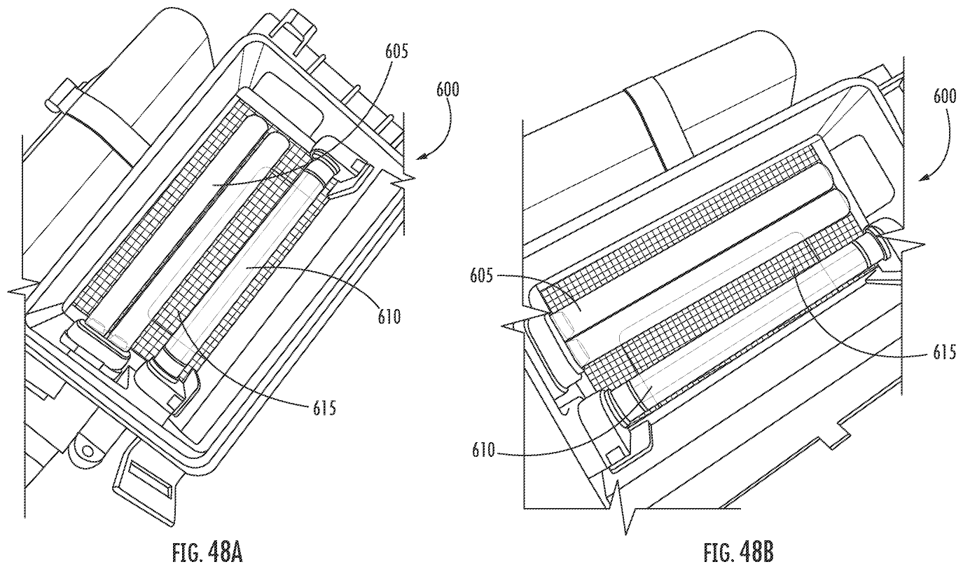

FIGS. 48A and 48B show a photocatalytic assembly component 600 for an air purification system (similar or identical to system 200) that may be retrofit to existing air circulation ducts within a vehicle, according to an exemplary embodiment. Component 600 includes UV light sources 605 and 610, which may provide UV-A and UV-C light, respectively, to energize one or more photocatalysts within a proximal filter 615. In various embodiments, UV light sources 605 and/or 610 may include tubes or LEDs. Filter 615, which may be energized by UV light sources 605 and 610, may facilitate removal and/or neutralization of contaminants within air flowing through photocatalytic assembly component 600. Although FIGS. 48A and 48B show photocatalytic assembly component 600 having one UV-A light source 605 and one UV-C light source 610, the component 600 may be configured to include any number of UV-A and/or UV-C light sources 605, 610. In various embodiments, a number of UV-A and/or UV-C light sources 605, 610 may be based on a desired level of intensity, which may affect a time required to purify air flowing therethrough.

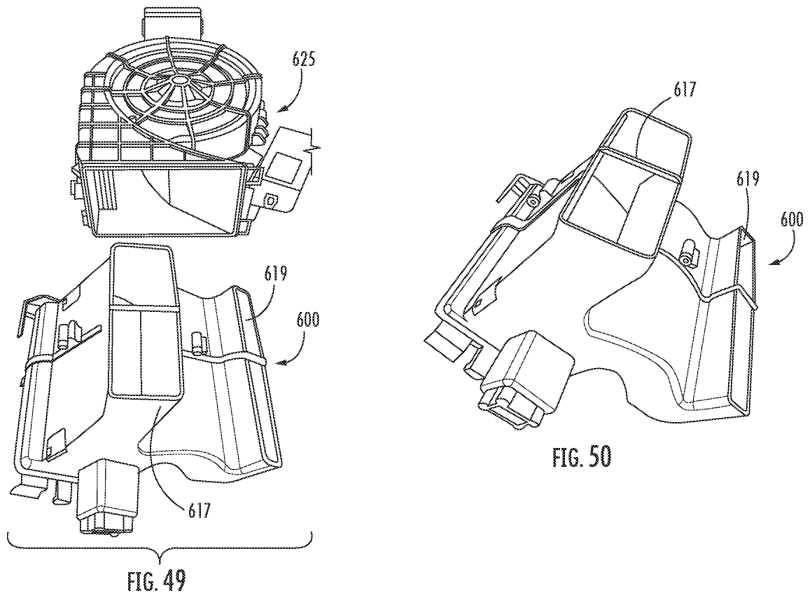

FIGS. 49 and 50 shows a photocatalytic assembly component 600 positioned near and connectable to a blower assembly component 625, which may be implemented within various embodiments of an air purification system (similar or identical to system 200). In various embodiments, blower assembly component 625 may be coupled to photocatalytic assembly component 600 to facilitate forced airflow through photocatalytic assembly component 600 via airways 617 and 619. In various embodiments, blower assembly component 625 may be coupled to a portion of photocatalytic assembly component 600 opposite airways 617 and 619. In various embodiments, components 600 and 625 may be configured to couple to existing air circulation ducts within a vehicle, either upstream or downstream from an HVAC system, to enable purification of air circulating therethrough. Although FIGS. 49 and 50 show the photocatalytic assembly component 600 having only two airways 617, 619, the component 600 may be configured to include any number of airways, each equivalent airways 617, 619. In various embodiments, the number of airways in the photocatalytic assembly component 600 may be based on a particular ductwork structure or design of the vehicle in which the air purification assembly is disposed.

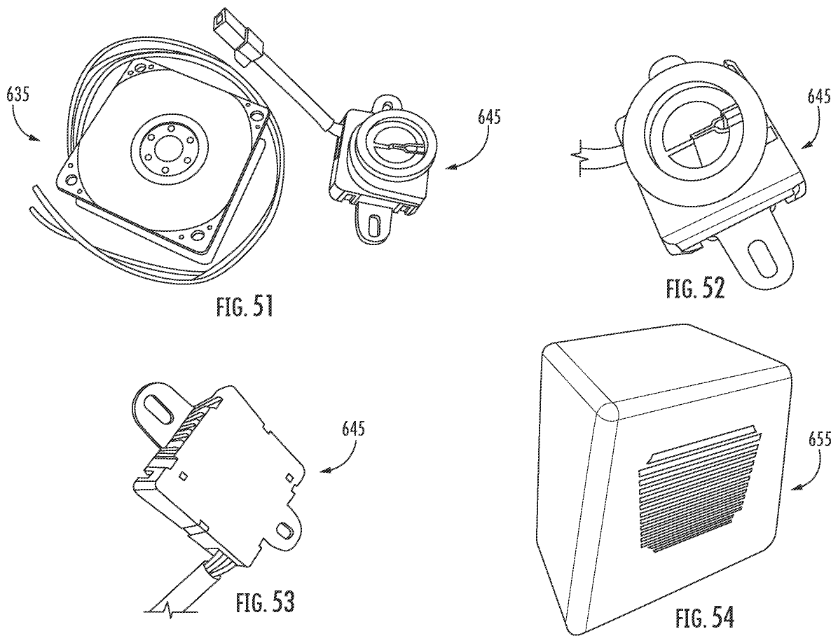

Air purification systems (i.e., similar or identical to systems 100, 200, 300, 400, 500) may be readily scalable to accommodate various sizes of photocatalytic assemblies (e.g., similar or equivalent to assembly 240) or air purification assemblies (e.g., similar or equivalent to assemblies 117, 330, 430) and implement varying types of air circulation mechanisms. FIGS. 51-53 show alternate views of a compact fan 635 and blower 645, which may be implemented in various embodiments of a standalone air purification system (similar or identical to systems 300 or 400). Fan 635 or blower 645, as shown, may be used to force air into and/or out of an air purification system. As shown, fan 635 and blower 645 are relatively compact, and thereby reduce the amount of space needed within an air purification system (similar or identical to system 300 or 400). In various embodiments, the fan 635 and/or blower 645 may be small enough to fit within a human hand, and thus contributing to reducing the amount of needed space for the air purification system and improving portability thereof. Smaller components, such as fan 635 and/or blower 645, would consequently contribute to a reduced footprint, power draw, and heat generation of an air purification system (similar or identical to system 300 or 400).

FIG. 54 shows a perspective view of a standalone air purification system 655 (similar or identical to system 300, according to an exemplary embodiment. FIG. 54 shows a potential configuration of a standalone air purification system 655 (similar or identical to system 300) which may contain LEDs tuned to desired UV wavelengths and other compact components, such as fan 635 and/or blower 645. Although FIG. 54 shows the standalone air purification system 655 having a trapezoidal shape, the standalone air purification system may be configured to have any polygonal shape to accommodate purifying air within a space. In various embodiments, the air purification system 655 may be communicatively coupled to one or more controllers, which may be configured to control at least one of a runtime, an air circulation rate, or an intensity of the one or more UV-tune LEDs contained therein.

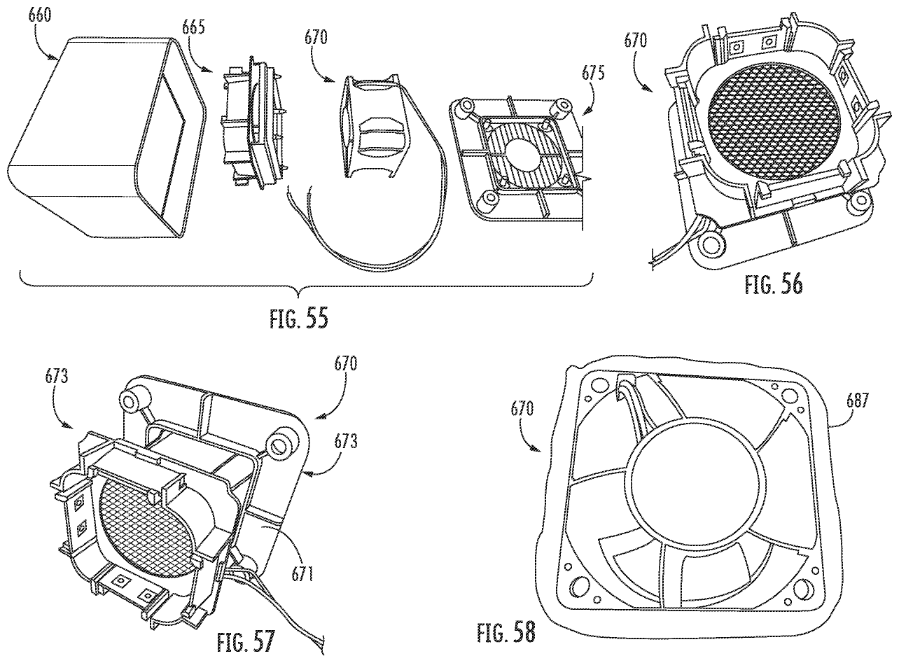

FIG. 55, in accordance with an exemplary embodiment, shows various components that may be implemented within an air purification system configured as a standalone unit (similar or identical to system 500). FIG. 55 shows an example housing 660, an example purification assembly 665, a blower assembly 670, and a back plate 675. In various embodiments, purification assembly 665 and blower assembly 670 may fit within housing 660. In various embodiments, purification assembly 665 may include a plurality of UV light sources, which may further include one or more tubes, lightbulbs, and/or LEDs configured to provide UV-A and/or UV-C wavelengths. In various embodiments, interior surfaces of at least one of the housing 660 and the back plate 675 may be coated with a reflective coating configured to reflect UV light generated by the purification assembly 665 and prevent radiation of the UV light outside of the air purification system.

FIGS. 56-57 show alternate views of a blower assembly 670, which may be housed within an air purification system to pull in ambient air. Blower assembly 670 may include a pull-through fan or blower. In various embodiments, blower assembly 670 may be coupled to a photocatalytic filter, which may include one or more photocatalysts (e.g., TiO₂, carbon). As shown, the blower assembly 670 may be configured such that a central region 671 of the blower assembly 670 has a decreased width or radius compared to outer portions 673 (i.e., where the blower assembly 670 may be coupled to the air purification system). Accordingly, in various embodiments, the blower assembly 670 may be wrapped or otherwise insulated with one or more noise-dampening materials 687. As shown in FIG. 58, the central region 671 of the blower assembly 670 may be wrapped with noise-dampening materials 687 to reduce noise emanating from the blower assembly 670.

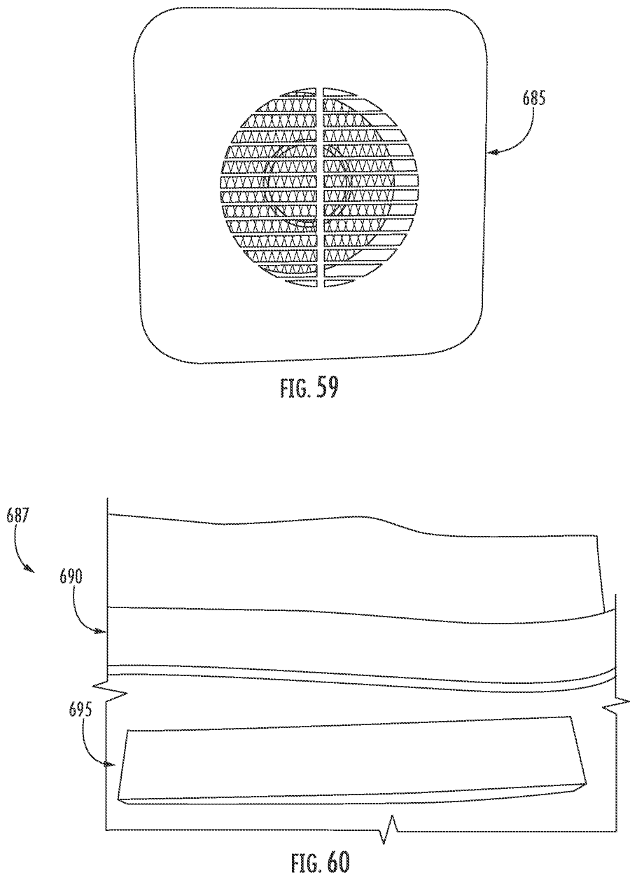

FIG. 59 shows an example of an air purification system 685 configured as a small standalone unit, according to an exemplary embodiment. In various implementations, system 685 may be housed or mounted within a vehicle or high-occupancy transportation system. In various embodiments, system 685 may include one or more UV light sources (e.g., tubes, bulbs, LEDs) that may energize one or more adjacent photocatalysts (e.g., TiO₂, carbon) to purify air drawn into system 685 by a contained fan and/or blower. In some embodiments, the air purification system 685 may be lined with noise-dampening materials 687 to reduce noise produced by the system. In various embodiments, the noise-dampening materials 687 may be disposed along interior surfaces of the air purification system 685 and/or surrounding an air circulation assembly (e.g., blower assembly 670) disposed therein. As illustrated in FIG. 59, the air purification system 685 may configured as a portable compact unit, which may be used in vehicles, offices, and/or residences.

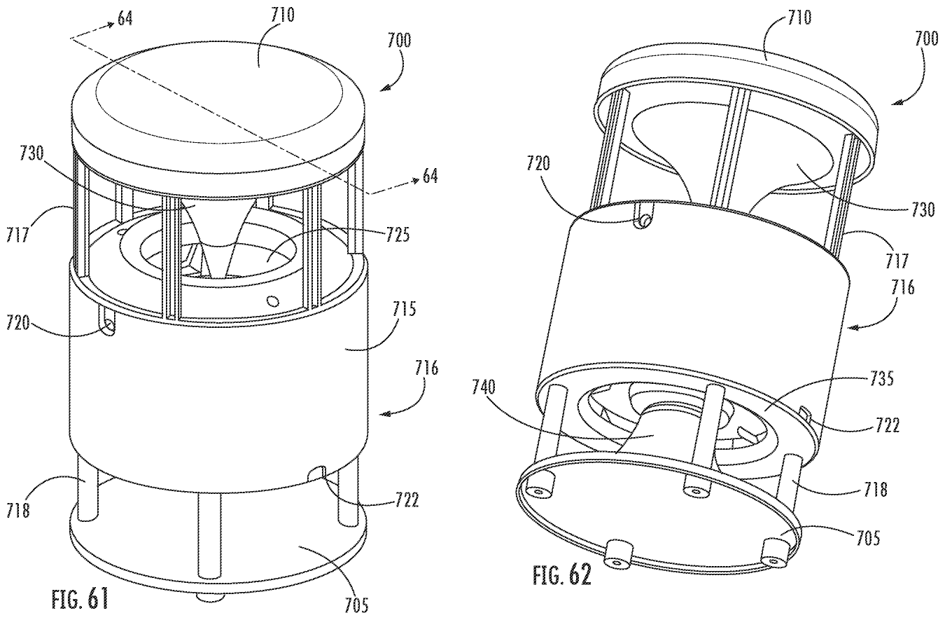

In various embodiments, the one or more noise-dampening materials 687 may be applied within the air purification systems (e.g., systems 100, 200, 300, 400, 500, 655, 685) to reduce noise. The noise-dampening materials 687 may be laminar sheets or strips, which may be attached to or positioned within the air purification system (e.g., surrounding an air circulator or blower assembly). FIG. 60 shows example noise-dampening materials 687 that may be implemented within an air purification system to reduce noise. As shown in FIG. 60, materials including, but not limited to, urethane 690 and ethylene propylene diene monomer rubber 695, may be used to reduce noise and vibration within an air purification system. In various embodiments, materials 690 and/or 695 may line surfaces within an air purification system, such as inner surfaces of housing and/or surrounding an air circulation system disposed therein. In various embodiments, a width or thickness of the materials 690 and/or 695 may be based on a degree of desired noise and/or vibration dampening. In various embodiments, an amount of noise-dampening material 687 within the air purification system may be based on a desired airflow through the air purification system.

FIGS. 61 and 62 show alternate perspective views of an air purification system 700, according to an exemplary embodiment. The air purification system 700 may be configured to purify or otherwise reduce various contaminants within a space. In various embodiments, such contaminants may include, but are not limited to viral, bacterial, and fungal impurities. The air purification system 700 includes an inlet housing 705 and an outlet housing 710, which are coupled to an outer shell 715 at a first end and a second end, respectively. The outer shell 715 is configured to enclose an air purification assembly 716, which is configured to purify air that flows into the air purification system 700. Although FIGS. 61 and 62 show the outer shell 715 as being generally cylindrical, the outer shell 715 may be conical, spherical, polygonal, or any other suitable shape. As shown, a bottom portion of the inlet housing 705 is distanced from the outer shell 715 by struts 718, which are vertically disposed between the inlet housing 705 and the outer shell 715. The distance between the outer shell 715 and the inlet housing 705 facilitates airflow into the air purification system 700. Similarly, a top portion of the outlet housing 710 is distanced from the outer shell 715 by struts 717, which are vertically disposed between the outlet housing 710 and the outer shell 715. The distance between the outer shell 715 and the outlet housing 710 enables flow of purified air out of the air purification system 700.

As shown, the air purification system 700 includes a control switch 720, which is disposed within the outer shell 715 and is configured to control operation of the air purification system 700. In various embodiments, the control switch 720 may be a button, lever, touch-sensitive region, or any other suitable mechanism to facilitate control of the air purification system 700. In various embodiments, the control switch 720 may be configured to turn the air purification system 700 on or off. In other embodiments, the control switch 720 may be configured to switch between one or more modes of operation. The air purification system 700 may also include an electrical port 722, which may be disposed within the outer shell 715 and is connectable to one or more power sources used to power the air purification system 700. In various embodiments, the air purification system 700 may be powered by one or more batteries (i.e., disposed within the outer shell 715) and the electrical port 722 may facilitate charging or recharging of the one or more batteries.

As illustrated in FIGS. 61 and 62, each of the inlet housing 705 and the outlet housing 710 may include various contours or other features to facilitate smooth airflow into and out of the air purification system 700. As evident from FIG. 62, the inlet housing may include a central conical structure 740, which may be smooth and may direct air into a curved receiving region 735 of the air inlet housing 705. Similarly, as evident from FIG. 61, the outlet housing may include a central conical structure 730, which may be smooth and may direct air away from a curved region 725 of the air outlet housing 710.

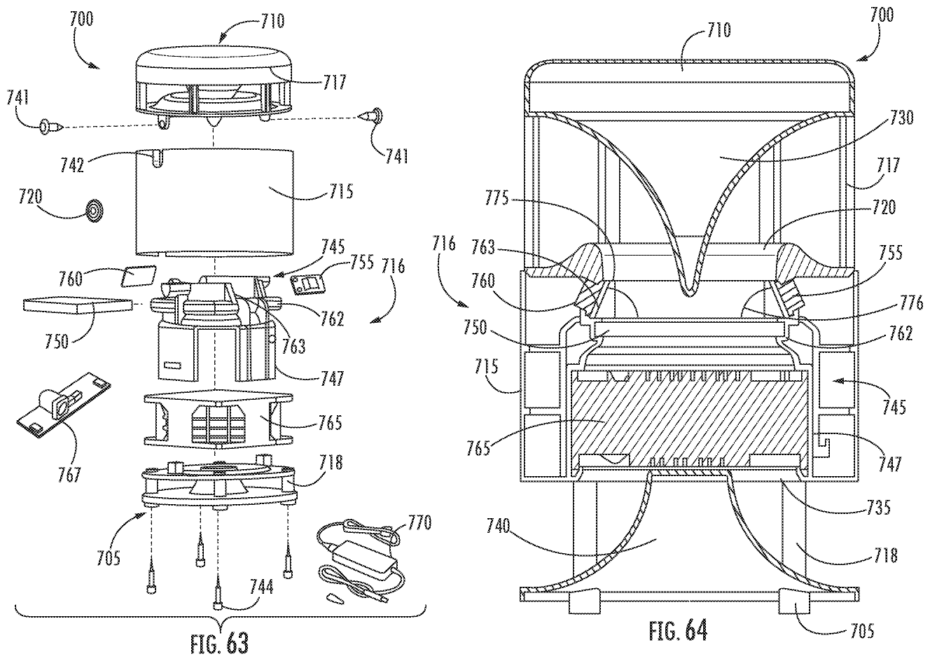

FIG. 63 shows an exploded view of the air purification system 700, according to an exemplary embodiment. As shown, the inlet housing 705 and the outlet housing 710 may be coupled to the outer shell 715 via one or more fasteners 741, 744. The outer shell 715 may also include a recess 742, which may surround the control switch 720. As described above, the outer shell 715 is configured contain the air purification assembly 716 disposed therein. The air purification assembly 716 is configured to purify air flowing into the air purification system 700 by removing impurities.

The air purification assembly 716 includes a filter housing 745. The filter housing 745 is configured to house a filter 750, which is received and held within a fixture 762. The filter 750 may include titanium dioxide (TiO₂) and carbon, or other similar compounds known in the art that are configured to remove and/or neutralize viruses, bacteria, and VOCs from circulating air. In various embodiments, the filter 750 may be similar or equivalent to the filters 130, 275, 353, 540, and/or 640. Example VOCs that may be removed by filter 750 may include, but are not limited to, odors, mold (e.g., Aspergilus Niger), mildew, bacteria (e.g., bacillus globigii, influenza, staphylococcus epidermidis, erwinia herbicola), bacteriophages (e.g., Escherichia virus MS2, Phi-174) etc. Other example VOCs may include acetaldehyde, formaldehyde, benzene, toluene, xylene, or other materials that may be found within a vehicle, residence, or office space, such as debris or decomposition materials from carpet, adhesives, tapes, solvents, paints, etc. In various implementations, filter 750 may include a glass fiber (e.g., high-efficiency particulate air layer) or other layer comprised of materials known in the art to trap and remove particulates from circulating air. In other embodiments, filter 750 may have a single layer comprising one or more photocatalysts (e.g., TiO₂ and carbon) and non-photocatalytic elements, such as a particulate trap (e.g., glass fiber).

As shown, the air purification system includes at least one UV-A light source 755 and at least one UV-C light source 760. In various embodiments, the UV light sources 755, 760 may be LEDs tuned to the appropriate UV wavelengths (i.e., UV-A and UV-C wavelengths). Accordingly, as described above, the UV-A and UV-C light sources 755, 760 may output UV light, which may interact with a TiO₂ surface within filter 750 within filter 750 through photocatalysis to generate electrons, which interact with water (H2O) molecules in the air to create hydroxyl radicals. These highly reactive hydroxyl (OH) radicals neutralize hydrocarbon-containing elements passing through the air (e.g., viruses, bacteria, pathogens, VOCs, etc.) by breaking down the complex molecules into water and carbon dioxide (CO2) constituents. The UV-A and UV-C light sources 755, 760 may be received within fixtures 763 within the filter housing 745. The fixtures 763 may be disposed within the filter housing 745 at positions such that the UV-A and UV-C light sources 755, 760 are oriented toward the filter 750 to energize or otherwise activate the filter 750 and enable neutralization and removal of VOCs from air flowing into the air purification system 700.

The filter housing 745 includes protruding sections 747, which extend downward from the fixtures 763 and 764. The sections 747 are configured to receive an air circulation unit 765, which is configured to draw air into the air purification system 700 through the air inlet housing 705 and push purified air out of the air purification 700 through the air outlet housing 710. In various embodiments, the air circulation unit 765 may be or include one or more fans and/or blowers, or any other suitable device configured to circulate air. An amount of air circulation (e.g., airflow) and/or an intensity of the UV-A and UV-C light sources 755, 760 may be controllable via a controller or voltage regulator 767. In various implementations, the voltage regulator 767 may be disposed within the filter housing adjacent the air circulation unit 765.

As described above, the air purification system 700 may be connectable to a power source via the port 722. As shown in FIG. 63, the air purification system 700 may include a power cord or adapter 770, which is configured to enable supply of power to the air purification system 700.

FIG. 64 shows a cross-sectional view of the air purification system 700 taken along line 64-64 of FIG. 61. As illustrated in FIG. 64, the inlet housing 705 and the outlet housing 710 are coupled to the outer shell 715, which encases the air purification assembly 716 and the air circulation unit 765. The air purification system 700 is configured such that the air circulation unit 765 is disposed near a bottom portion of the outer shell 715 adjacent the inlet housing 705. Accordingly, the filter 750 is disposed above the air circulation unit. The UV-A and UV-C light sources 755, 760 are disposed within the filter housing 745 such that each of the UV-A and UV-C light sources 755, 760 are oriented at an angles 775, 776, respectively, relative to the filter 750, which is positioned horizontally within the air purification system 700. In various embodiments, the angle 775, 776 are such that the UV-A and UV-C light sources 755, 760 illuminate most or all of a top surface of the filter 750 (i.e., to maximize activation of the filter 750). In various embodiments, the angles 775, 776 may be adjustable based on a desired intensity of the UV-A and UV-C light sources 755, 760 and/or level of activation of the filter 750. In some embodiments, the angle 775 may be the same as angle 776. In other embodiments, the angles 775 and 776 may be different.

In various embodiments, the air purification system 700 may include insulation (e.g., equivalent or similar to noise-dampening materials 687) to reduce noise and vibration produced by the system 700. The insulation may be disposed within at least one of the air inlet housing 705, the air outlet housing 710, or the outer shell 715 (e.g., such as a lining of the interior surfaces). In various embodiments, an amount or degree of insulation and/or a placement of the insulation within the air purification system 700 may be based on an air pressure drop through the air purification system 700. Accordingly, the amount of insulation may be designed to accommodate a minimum airflow requirement or may be optimized based on a desired noise or vibration level. In various embodiments, at least one of the airflow requirement, noise level, or vibration level may be selected or optimized based on a use application of the air purification system 700. In various embodiments, an inner surface of at least one of the inlet housing 705, the outlet housing 710, or the outer shell 715 may be coated with a reflective coating configured to reflect UV light. Such a coating would thus prevent or reduce UV exposure (i.e., resulting from the air purification assembly 716) outside of the air purification system 700.

In other implementations, an air purification system may be configured to include fewer housing components. FIGS. 65-67 show perspective and top views of an air purification system 800, according to an exemplary embodiment. The air purification system 800 may include an air inlet 805 and an air outlet 810, which are formed as openings within a housing of the air purification system 800. The housing may include a front housing section 815 and a rear housing section 817, which are joined on opposite sides via joints 819. As illustrated, the air inlet 805 may be disposed within a bottom portion of the housing sections 815, 817 and the air outlet 810 may be disposed within a top portion of the housing sections 815, 817. The front housing section 815 may include a control switch 820, which may be similar or equivalent to the control switch 720. The air purification system 800 includes an air purification assembly 816, which is contained within the housing sections 815, 817 and disposed above the air inlet 805 and below the air outlet 810. The air purification system 800 may be configured to have a small footprint so as to enable placement and use in a variety of locations and for various applications (e.g., vehicle, home, office, etc.). In some embodiments, the air purification system 800 may have a width of approximately 160 mm and a width and thickness of approximately 150 mm.

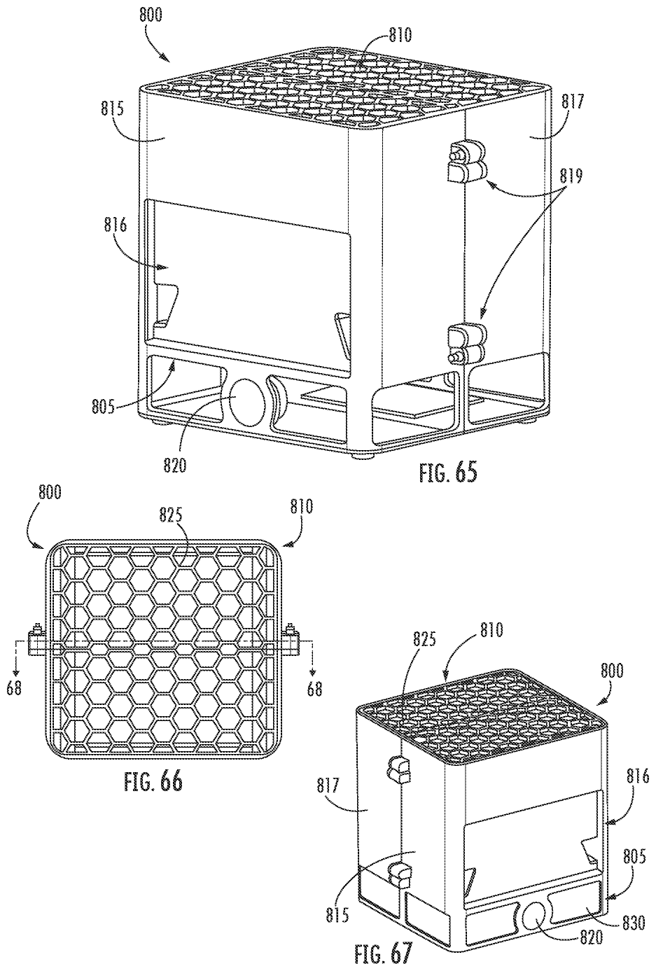

As shown in FIGS. 66 and 67, the air purification system 800 may include wire or meshed coverings on at least one of the air inlet 805 or the air outlet 810. As illustrated in FIG. 66, the air outlet 810 may be covered with a meshed or wired covering 825, which may extend between the housing sections 815, 817. In various embodiments, the covering 825 may be a metallic, polymeric, or other non-metallic covering. In various embodiments, at least one of the covering 825 or an inside surface of the housing sections 815, 817 may be coated with UV-reflective coat to prevent UV exposure through a top portion of the air purification system 800. As illustrated in FIG. 67, the air inlet 805 may similarly be covered by a mesh or wired covering 830, which may be disposed within openings in each of the housing sections 815, 817. Similarly, the covering 830 may be a metallic, polymeric, or other non-metallic covering, which may, in some embodiments, coated with a UV-reflective coating.

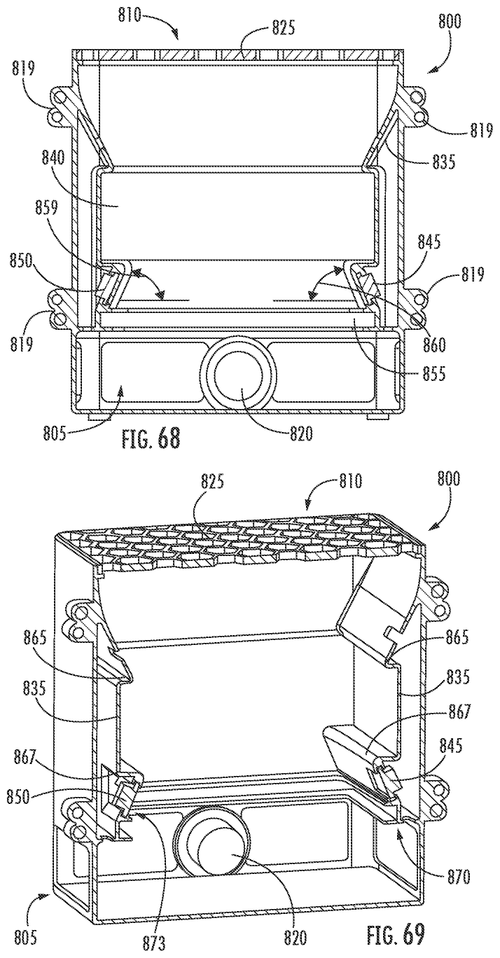

FIG. 68 shows a cross-sectional view of the air purification system 800 taken along line 68-68 of FIG. 66. As illustrated, the housing sections 815, 817 include an inner mount 835, which is configured to hold the air purification assembly 816 and an air circulation unit 840 in place within the air purification system 800. The air purification assembly 816 may be positioned above the air inlet 805 and configured such that UV-A and UV-C light sources 845, 850 are disposed above a filter 855. Each of the UV-A and UV-C light sources 845, 850 and the filter 855 may be similar or equivalent to each of the UV-A and UV-C light sources 755, 760 and the filter 750, respectively. The UV-A and UV-C light sources 845, 850 may be mounted within the air purification system 800 (i.e., via the mount 835) at angles 859, 860 relative to the filter 855, which is disposed horizontally within the air purification system 800. The angles 859, 860 at which the UV-A and UV-C light sources 845, 850 are respectively mounted may enable illumination of most or all of the filter 855. The air circulation unit 840, which may be similar or equivalent to the air circulation unit 765, may be disposed above the air purification assembly 816. In various embodiments, the angles 859 and 860 may be the same or different based on at least one of a desired light intensity, filter illumination, or use application of the air purification system 800. In various embodiments, the UV-A and UV-C light sources 845, 850 may be configured to extend along a portion of a length of the housing portions 815, 817. In other embodiments, the UV-A and UV-C light sources 845, 850 may be configured to extend along substantially an entire length of the housing portions 815, 817. In other embodiments, a size or length of the UV-A and UV-C light sources 845, 850 may be based on a size of the filter 855.

During use, the control switch 820 may turn the air purification system 800 on, which may turn on each of the air circulation unit 840 and the air purification assembly 816. Accordingly, the UV-A and UV-C light sources 845, 850 may illuminate and activate the filter 855, which neutralizes and removes VOCs and other impurities within air that is drawn into the air purification system 800 by the air circulation unit 840.

FIG. 69 shows a perspective cross sectional view of the air purification unit 800 with the filter 855 and air circulation unit 840 removed. As shown, the mount 835 of the housing sections 815, 817 includes protruding features or brackets 865, which are configured to hold the air circulation unit 840 in place above the air purification assembly 816. The protruding features or brackets 865 may be integrally formed within the mount 835 or may be implement one or more fasteners and coupled components. The mount 835 also includes ridged portions 870, which may protrude from an inner surface of the housing sections 815, 817. The ridged portions 870 may be configured to hold and maintain the filter 855 horizontally within the air purification system 800 such that air drawn in through the air inlet 805 passes through the filter 855. The ridged portions 870 and the protruding features or brackets 865 may form a holding region 873, within which the UV-A and UV-C light sources 845, 850 may be positioned.

In various embodiments, the air purification system 800 may include insulation (e.g., equivalent or similar to noise-dampening materials 687) to reduce noise and vibration produced by the system 800. The insulation may be disposed within the housing sections 815, 817, such as lining interior surfaces thereof. In various embodiments, an amount or degree of insulation and/or a placement of the insulation within the air purification system 800 may be based on an air pressure drop through the air purification system 800. Accordingly, the amount of insulation may be designed to accommodate a minimum airflow requirement or may be optimized based on a desired noise or vibration level. In various embodiments, at least one of the airflow requirement, noise level, or vibration level may be selected or optimized based on a use application of the air purification system 800. In various embodiments, a speed of air circulation through the air purification system 800 may be adjusted based on a desired noise level. In various embodiments, the air circulation unit 840 may include a blower or fan. In some embodiments, the air circulation unit 840 may include a pulse-width modulation (PWM) fan. In various embodiments, the PWM fan may be controllable via one or more controllers disposed within the air purification system 800 and/or one or more controllers located remotely from the air purification system 800.

In various embodiments, the air purification systems 700 and/or 800, or any of the preceding embodiments of the air purification system (e.g., system 100, 200, 300, 400, 500, 655, 685) may be configured to target neutralization and removal of specific viral, bacterial, fungal, or other impurities present in ambient air. Target neutralization may be implemented by controllable adjustment of at least one of a runtime (e.g., of the air purification assembly 716, 816 and/or the air circulation unit 765, 840). In various embodiments, the air purification systems 700 and/or 800, or any of the preceding embodiments may be configured to target removal of at least one of Bacillus globigii (e.g., influenza), Phi-174 (i.e., DNA, herpes, HIV), Apergilus Niger (i.e., black mold), Staphylococcus epidermidis (e.g., anthrax), Erwinia herbicola (i.e., bacterium found in plants, soil, water), Escherichia virus MS2, SARS-Cov-2, and Coronavirus. Experimental tests implementing air purification systems 700, 800 have shown greater than 90% effectiveness at removing various pathogenic impurities. In an experiment using Escherichia virus MS2, the air purification systems were found to successfully reduce the MS2 concentration in surrounding ambient air by more than 94% after a mere 15 minutes of operation. Additional runtime of the air purification systems 700, 800 increased impurity reduction to greater than 99% after 30 minutes, reaching 99.9% reduction after just 60 minutes of operation. Moreover, the MS2 virus has a size of approximately 0.027 microns and is a known proxy for SARS-Cov-2—a precursor to Coronavirus (COVID-19), which has a size of approximately 0.125 microns. Accordingly, the air purification systems 700, 800 may be configured to effectively remove various infectious viruses from ambient air, including, but not limited to, COVID-19. In related studies, the air purification systems 700, 800 were found to cause more than 90% reduction in ambient air concentrations of Bacillus globigii (e.g., influenza), Phi-174 (i.e., DNA, herpes, HIV), Apergilus Niger (i.e., black mold), Staphylococcus epidermidis (e.g., anthrax), Erwinia herbicola (i.e., bacterium found in plants, soil, water), and other bacterial, viral, and fungal VOCs. Furthermore, the runtime and/or UV light source intensity within the air purification systems 700, 800 may be adjusted to increase effectiveness or to more quickly neutralize or remove impurities.

In addition to providing effective neutralization of impurities, the air purification systems 700, 800 were also experimentally determined to produce minimal ozone, which may be generated through use of UV lights. During experimentation, it was determined that use of the air purification systems 700, 800 produced trace ozone levels that were scarcely detectable by standard sensors. Accordingly, the air purification systems 700, 800 (and, similarly, systems 100, 200, 300, 400, 500, 655, and 685) may be used in a variety of applications to provide efficient neutralization and removal of air impurities and contaminants while posing little to no risk to surrounding users.

In any of the preceding embodiments, the air purification systems 100, 200, 300, 400, 500, 655, 685, 700, 800 may be configured to operate according to one or more preset modes. In various implementations, the one or more modes may be based on a runtime (i.e., a time during which the system operates) and/or an intensity of the UV light sources. In these embodiments, the air purification systems 100, 200, 300, 400, 500, 655, 685, 700, 800 may be configured to run over a predetermined time period. In some embodiments, the time period may be based on a contamination level (i.e., a number or an amount of VOCs in ambient air), a user setting, or a manufacturer setting. In various embodiments, the air purification systems 100, 200, 300, 400, 500, 655, 685, 700, 800 may include one or more sensors, wherein the one or more sensors may be configured to detect an air purity level and/or a concentration or presence of one or more impurities (i.e., VOCs) within ambient air. In some embodiments, the air purification systems 100, 200, 300, 400, 500, 655, 685, 700, 800 may include one or more sensors configured to detect viral impurities or other hydrocarbons present in ambient air. In some embodiments, the air purification system may be configured to operate as long as a threshold amount of viral impurities, hydrocarbons, or other VOCs are detected by the one or more sensors included in the air purification system. In some embodiments, the threshold amount of viral impurities, hydrocarbons, or VOCs may be set by a user or by a manufacturer, or may be based on a particular use application of the air purification system. In various embodiments, a speed or rate of air circulation (i.e., caused by air circulation mechanisms 135, 225; fan 335; blower 435, 670; and/or air circulation units 765, 840) may be controllable based on a detected impurity level or type of impurity.

In various embodiments, the air purification systems 100, 200, 300, 400, 500, 655, 685, 700, 800 may be configured to increase or decrease diode intensity of the UV-A and/or UV-C light sources contained therein based on a particular application, sensed impurity or detected air quality, and/or based on a runtime (e.g., as selected by a user) of the system. In various embodiments, a number of UV-A and UV-C light sources (i.e., a number of light-emitting diodes) in the air purification systems 100, 200, 300, 400, 500, 655, 685, 700, 800 may be based on a particular intended application for the air purification system. In various embodiments, an amount of insulation (i.e., amount of noise-dampening material, such as material 687) within the air purification systems 100, 200, 300, 400, 500, 655, 685, 700, 800 may be based on a particular intended application and/or optimized to meet a predetermined airflow or pressure drop set point.

Notwithstanding the embodiments described above in FIGS. 1-69, various modifications and inclusions to those embodiments are contemplated and considered within the scope of the present disclosure.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

It is also to be understood that the construction and arrangement of the elements of the systems and methods as shown in the representative embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed.

Accordingly, all such modifications are intended to be included within the scope of the present disclosure. Any means-plus-function clause is intended to cover the structures described herein as performing the recited function and not only structural equivalents but also equivalent structures. Other substitutions, modifications, changes, and omissions may be made in the design, operating conditions, and arrangement of the preferred and other illustrative embodiments without departing from scope of the present disclosure or from the scope of the appended claims.

Furthermore, functions and procedures described above may be performed by specialized equipment designed to perform the particular functions and procedures. The functions may also be performed by general-use equipment that executes commands related to the functions and procedures, or each function and procedure may be performed by a different piece of equipment with one piece of equipment serving as control or with a separate control device.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent

Moreover, although the figures show a specific order of method operations, the order of the operations may differ from what is depicted. Also, two or more operations may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection operations, processing operations, comparison operations, and decision operations.

What is claimed is:

1. An air purification system comprising:
a housing having an air inlet and an air outlet;
an air circulation unit disposed between the air inlet and the air outlet, the air circulation unit configured to circulate air from the air inlet to the air outlet; and
an air purification assembly disposed adjacent the air circulation unit, the air purification assembly comprising:
a UV-A light source and a UV-C light source; and
a photocatalytic filter configured to activate responsive to light produced by each of the UV-A and UV-C light sources;
wherein the UV-A light source and the UV-C light source are disposed on a same side of the photocatalytic filter and oriented respectively at a first angle and a second angle relative to the same side of the photocatalytic filter to illuminate the photocatalytic filter; and
wherein the air purification assembly is configured to purify the air circulated by the air circulation unit.

2. The air purification system of claim 1, wherein an inside surface of the housing is coated with a UV-reflective coating.

3. The air purification system of claim 1, wherein the first angle is substantially the same as the second angle.

4. The air purification system of claim 1, wherein the housing comprises:
a first housing section; and
a second housing section coupled to the first housing section;
wherein the air inlet is formed within a bottom portion of each of the first housing section and the second housing section, and wherein the air outlet is formed within a top portion of each of the first housing section and the second housing section.

5. The air purification system of claim 4, wherein each of the air inlet and the air outlet are covered by a mesh covering.

6. The air purification system of claim 1, further comprising a mounting apparatus coupled to the housing.

7. The air purification system of claim 1, wherein a speed of air circulated by the air circulation unit is controlled based on at least one of a runtime or an impurity level.

8. The air purification system of claim 1, further comprising a controller, the controller configured to control at least one of a runtime, an air circulation rate, or an intensity of the UV-A and the UV-C light sources.

9. The air purification system of claim 1, wherein the air circulation unit comprises at least one of a blower or a fan.

10. The air purification system of claim 1, wherein each of the UV-A light source and the UV-C light source comprise one or more light emitting diodes (LEDs).

11. The air purification system of claim 10, wherein an intensity of the LEDs within each of the UV-A light source and the UV-C light source is adjusted based on a runtime of the air purification system.

12. An air purification system comprising:
an outer shell;
an inlet housing coupled to a first end of the outer shell; and
an outlet housing coupled to a second end of the outer shell;
wherein air is received through the inlet housing and expelled through outlet housing;
wherein the outer shell configured to enclose an air circulation unit and an air purification assembly disposed adjacent the air circulation unit, the air purification assembly comprising:
a first UV light source and a second UV light source; and
a photocatalytic filter configured to activate responsive to light produced by each of the first UV light source and the second UV light source;
wherein the first UV light source and the second UV light source are disposed on a same side of the photocatalytic filter configured to illuminate the photocatalytic filter and are positioned respectively at a first angle and a second angle relative to the same side of photocatalytic filter; and
wherein the air purification assembly is configured to purify the air circulated by the air circulation unit.

13. The air purification system of claim 12, wherein the first UV light source is a UV-A light source and the second UV light source is a UV-C light source.

14. The air purification system of claim 12, wherein each of the first UV light source and the second UV light source are LEDs.

15. The air purification system of claim 14, wherein an intensity of the first UV light source and the second UV light source is adjusted to target neutralization of one or more impurities.

16. The air purification system of claim 14, wherein a runtime of at least one of the air purification assembly or the air circulation unit is adjusted to target neutralization of one or more impurities.

17. The air purification system of claim 16, wherein the one or more impurities is selected from the list comprising: Bacillus globigii, Phi-174, Apergilus Niger, Staphylococcus epidermidis, Erwinia herbicola, Escherichia virus MS2, SARS-Cov-2, and Coronavirus.

18. The air purification system of claim 12, further comprising a noise-dampening material disposed between the outer shell and at least one of the air purification assembly or the air circulation unit.

19. The air purification system of claim 12, wherein an inside surface of at least one of the outer shell, the inlet housing, or the outlet housing is coated with a UV-reflective coating.

20. A method of purifying ambient air in a confined space by an air purification system, the method comprising:
illuminating, by a first UV light source and a second UV light source, a photocatalytic filter disposed within a filter housing, wherein the first UV light source and the second UV light source are disposed on a same side of the photocatalytic filter, and wherein the first UV light source and the second UV light source are oriented at a respective first angle and a second angle relative to the same side of the photocatalytic filter; and
circulating, by an air circulation unit disposed adjacent the photocatalytic filter, air through the photocatalytic filter;
wherein the photocatalytic filter activates responsive to illumination by the first UV light source and the second UV light source, and wherein the photocatalytic filter is configured to neutralize volatile organic compounds (VOCs) within the air when activated;
wherein air circulation unit is configured to draw the air through an inlet housing and expel the air through an outlet housing, and wherein the inlet housing and the outlet housing are respectively coupled to a first end and a second end of an outer shell;
wherein the outer shell is configured to contain the first UV light source, the second UV light source, and the filter housing, and the air circulation unit; and
wherein the first UV light source is a light emitting diode tuned to a UV-A wavelength and the second UV light source is a light emitting diode tuned to a UV-C wavelength.
